(19) United States
(12) Patent Application Publication
(10) Pub. No.: US 2026/0208599 A1
(43) Pub. Date: Jul. 23, 2026

(54) SYSTEM FOR CONTROLLING BRAKING/TRACTION OF AN ELECTRIC OR HYBRID VEHICLE

(71) Applicant: Brembo S.p.A., Curno, Bergamo (IT)

(72) Inventors: Carlo CANTONI, Curno, Bergamo (IT); Giacomo URSO, Curno, Bergamo (IT); Alex GIMONDI, Curno, Bergamo (IT); Giorgio RIVA, Curno, Bergamo (IT); Roberto ARIENTI, Curno, Bergamo (IT)

(21) Appl. No.: 19/138,732

(22) PCT Filed: Nov. 27, 2023
(86) PCT No.: PCT/IB2023/061929

§ 371 Date: Jun. 13, 2025

(30) Foreign Application Priority Data
Dec. 15, 2022 (IT) 102022000025683

(51) Int. Cl. B60L 15/20; B60L 3/00; B60L 7/18; B60L 50/64

(52) U.S. Cl. CPC B60L 15/2009; B60L 3/0061; B60L 3/0076; B60L 7/18; B60L 50/64

(57) ABSTRACT

A system for controlling the braking/traction of an electric or hybrid vehicle, comprising: a vehicle control unit configured to receive: a braking or traction target value to be imparted to the vehicle determined by a vehicle control unit based on a braking or traction request; first input information representative of the battery pack; second input information representative of a regenerative braking or traction phase performed by the system on the braking/traction system by means of at least one first electric motor; third input information representative of a dissipative braking phase performed by the system on the braking/traction system of the vehicle by means of at least one first dissipative braking torque actuation module; fourth input information representative of an operating condition of at least one first axle or a vehicle corner connected to the at least one first axle. The vehicle braking/traction control unit is configured to determine a first regenerative braking torque or traction target value to be imparted to the vehicle by means of the at least one first electric motor and a first dissipative braking torque target value or a first hydraulic pressure target value to be imparted to the first front axle by means of the at least one first dissipative braking torque actuation module, based on the braking or traction target value to be imparted to the vehicle, the first input information, the second input information, the third input information, and the fourth input information.

### FIELD OF THE INVENTION

The present invention relates to a system for controlling braking/traction of an electric or hybrid vehicle.

### BACKGROUND ART

Nowadays, in a typical system for controlling braking/traction of an electric or hybrid vehicle, the vehicle control unit (VCU) is fully in charge of controlling the braking of a vehicle.

Indeed, the vehicle control unit is configured to receive and process the braking request from the driver of the vehicle, define the braking distribution between the front axle and the rear axle of the vehicle and/or between wheel corners of the vehicle, define the regenerative braking torque target and the dissipative braking torque target to be imparted to the braking system of the vehicle, i.e., to electric motors distributed on each axle and/or wheel corner of the vehicle and to actuators with B-b-W (Brake-by-Wire) technology also distributed on each axle and/or wheel corner of the vehicle.

The blending of regenerative braking torque and dissipative braking torque in the braking system with B-b-W technology of a vehicle is typically implemented using a sequential approach, when a first actuator is saturated, usually an electric motor, the residual braking request is sent to the next actuator and so on.

However, electric or hybrid vehicles are becoming more and more complex with more and more subsystems, such as battery packs, one or more electric motors, actuators, and B-b-W components, for example, to be taken into account when controlling the traction and braking of the electric or hybrid vehicle, which makes the sequential approach mentioned above not always optimal.

Moreover, considering that the dissipative braking torque target to be imparted to the braking system with B-b-W technology of the vehicle is typically a braking fluid pressure value and the vehicle control unit, once it receives the braking request from the driver of the vehicle, is configured to define the dissipative braking torque target to be imparted to the braking system of the vehicle by performing a processing in terms of braking torque, it is necessary to perform a further conversion of the dissipative braking torque value into a braking fluid pressure value, which results in increasing the calculation time, by the vehicle control unit, which makes the control system less prompt and reliable.

In light of the above, the need is currently felt to provide an architecture and methodology for controlling braking/traction of an electric or hybrid vehicle which allows ensuring better braking system performance, higher efficiency, greater reliability, and prompt intervention.

### SUMMARY OF THE INVENTION

It is the object of the present invention to devise and provide a system for controlling braking/traction of an electric or hybrid vehicle which can overcome the limitations described above, ensuring better performance of the braking/traction system, greater reliability, and timeliness of intervention.

Such an object is achieved by a method according to claim 1.

Further advantageous embodiments are the subject of the dependent claims.

The present invention also relates to a method for controlling braking/traction of an electric or hybrid vehicle.

### BRIEF DESCRIPTION OF THE FIGURES

Further features and advantages of the system according to the invention will become apparent from the following description of preferred exemplary embodiments, given by way of non-limiting indication, with reference to the accompanying drawings, in which:

FIGS. 1a-1d each illustrate, by means of a block diagram, a system for controlling braking/traction of an electric or hybrid vehicle according to an embodiment of the present invention;

FIG. 2 shows, by means of a block diagram, a functional block of a system for controlling braking/traction of an electric or hybrid vehicle according to an embodiment of the present invention;

FIG. 3 shows, by means of a functional block diagram, a braking/traction system of an electric or hybrid vehicle according to an embodiment of the present invention;

FIG. 4 shows, by means of a functional block diagram, a braking/traction system of an electric or hybrid vehicle according to a further embodiment of the present invention;

FIG. 5 shows, by means of a functional block diagram, a functional block of a braking/traction system of an electric or hybrid vehicle according to an embodiment of the present invention;

FIG. 6 shows, by means of a functional block diagram, a functional sub-block of the functional block in FIG. 5 according to an embodiment of the present invention;

FIG. 7a shows, by means of a functional block diagram, a further functional sub-block of the functional block in FIG. 5 according to an embodiment of the present invention;

FIG. 7b shows, by means of a functional block diagram, a further functional sub-block of the functional block in FIG. 5 according to an embodiment of the present invention;

FIG. 8 shows, by means of a block diagram, a method for controlling braking/traction of an electric or hybrid vehicle according to an embodiment of the present invention;

FIG. 9 shows a motor friction map usable by the system of the present invention;

FIG. 10 shows a further pad/brake friction map usable by the system of the present invention.

It should be noted that equal or similar elements in the figures will be indicated by the same numeric or alphanumeric references.

### DESCRIPTION OF SOME PREFERRED EMBODIMENTS

Referring now to aforesaid figures, reference numeral 100 indicates as a whole a system for controlling braking/traction of an electric or hybrid vehicle, hereinafter also simply referred to as a control system or only system, according to the present invention.

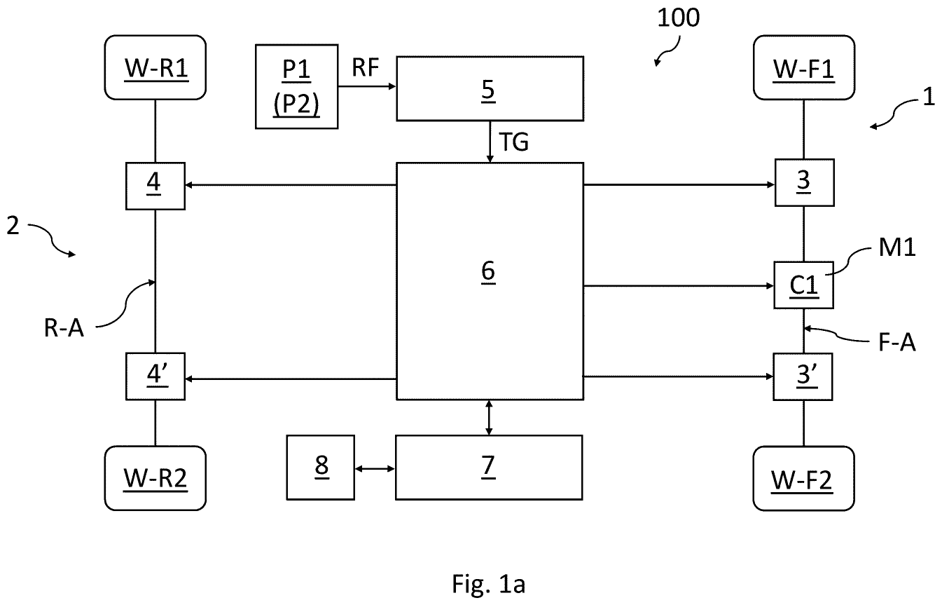

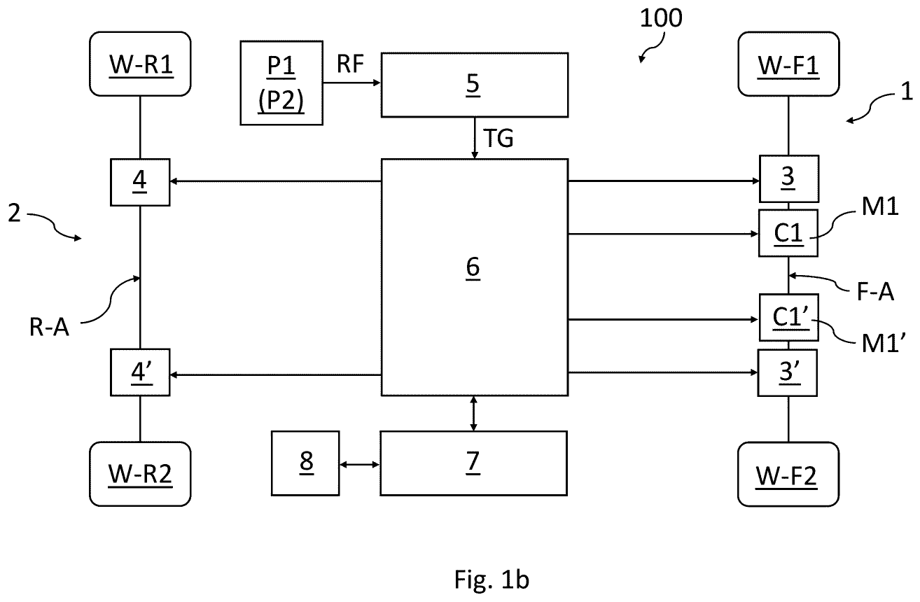

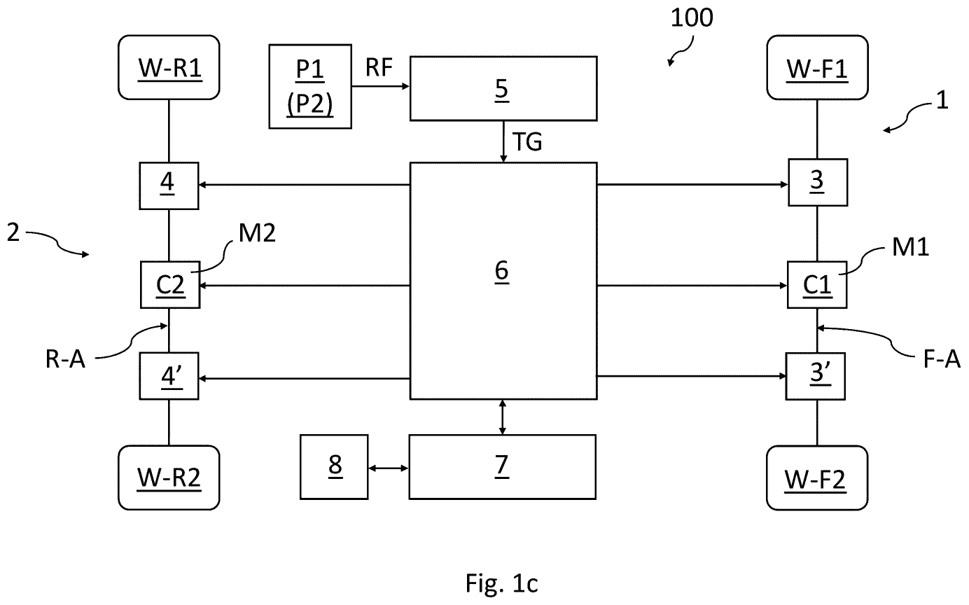

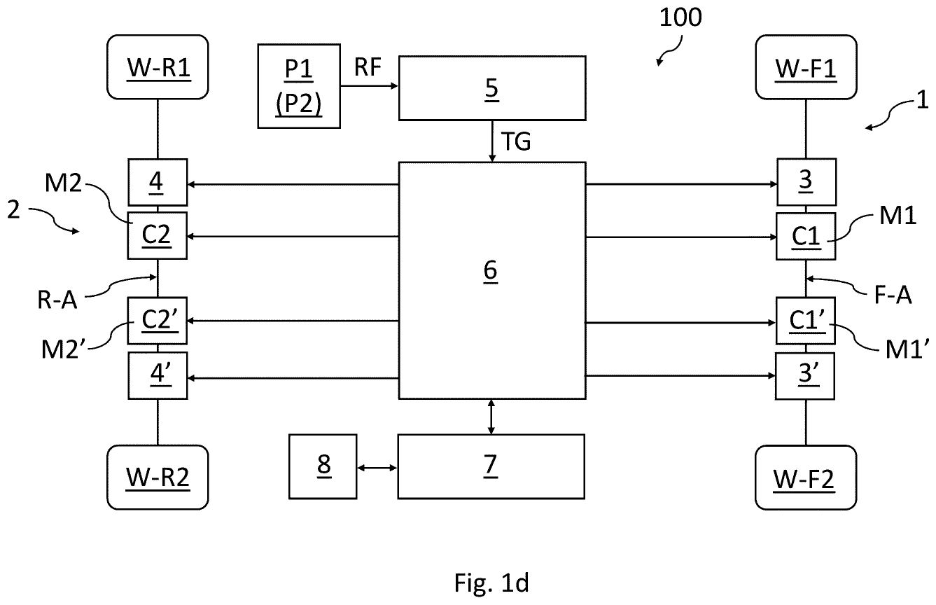

For the purposes of the present description, “vehicle” (shown only diagrammatically in FIGS. 1a-1d and indicated by reference numeral 1) means any vehicle or motorcycle, even of commercial or sporty type, even for motorsports, having two, three, four, or more wheels.

Moreover, “braking/traction system” means a set of all components (mechanical and/or hydraulic and/or electrical or electronic components) which contribute to the generation of service braking or the generation of parking braking of a vehicle and to the traction of the vehicle.

“Braking/traction control” means a controlled allocation of braking/traction to the components of the braking/traction system as defined above.

With reference to FIGS. 1a-1d, the vehicle 1 comprises at least one first axle F-A to which at least one first wheel W-F1 is connected.

The at least one first axle F-A is, for example, a front axle of the vehicle 1 and the first wheel W-F1 is, for example, a front wheel.

According to an embodiment, in combination with the preceding one and shown in FIG. 1a-1d, the vehicle 1 comprises at least one second wheel W-F2 connected to the first axle F-A.

In this embodiment, the at least one first axle F-A is, for example, a front axle of the vehicle 1, the first wheel W-F1 is, for example, the front left wheel, and the at least one second wheel W-F2 is the front right wheel.

In an embodiment in combination with any of the preceding ones and shown in FIG. 1a-1d, the vehicle 1 comprises at least one second axle R-A to which at least one further first wheel W-R1 is connected.

In this embodiment, if the at least one first axle F-A is, for example, the front axle of the vehicle 1, the at least one second axle R-A is a rear axle of the vehicle 1, and the at least one further first wheel W-R1 is, for example, a rear wheel.

According to an embodiment, in combination with the preceding one and shown in FIG. 1a-1d, the vehicle 1 comprises at least one further second wheel W-R2 connected to the at least one second axle R-A.

In this embodiment, if the at least one second axle R-A is the rear axle of the vehicle 1, the at least one further first wheel W-R1 is, for example, the rear left wheel, while the at least one second rear wheel W-R2 is, for example, the rear right wheel.

Returning in general to FIGS. 1a-1d, the vehicle 1 further comprises a braking/traction system 2.

According to an embodiment, in combination with any of the preceding ones and shown in FIG. 1a-1d, the braking/traction system 2 further comprises at least one first electric motor M1 operatively connected to the at least one first axle F-A.

The at least one first electric motor M1 comprises a respective first electric motor control module C1.

The first electric motor control module C1 is configured to control the at least one first electric motor M1 to provide a regenerative braking or traction torque required by the system 100 based on a received target value.

The first electric motor control module C1 is, for example, an appropriately configured hardware module or software logic module present inside a main hardware module of the braking/traction system 2 or, more in general, inside a hardware module of the vehicle 1.

The braking/traction system 2 of the vehicle 1 further comprises at least one first dissipative braking torque actuation module 3 operatively connected to the at least one first axle F-A.

In an embodiment, the at least one first dissipative braking torque actuation module 3 is with B-b-W technology, e.g., an electromechanical and/or electro-hydraulic actuator (EHA).

Therefore, the at least one first dissipative braking torque actuation module 3, diagrammatically shown as a single block in the figures, comprises at least one electromechanical or electro-hydraulic actuator, at least one electronic control unit, at least one brake assembly (i.e., assembly of brake caliper, brake disc, pad(s)), at least one set of hydraulic lines to connect the aforesaid components together. The at least one electronic control unit of the at least one first dissipative braking torque actuation module 3 is, for example, an appropriately configured hardware module or software logic present inside a main hardware module of the braking/traction system 2 or more in general inside a hardware module of the vehicle 1.

From a control point of view, the at least one first dissipative braking torque actuation module 3 is configured to receive a first dissipative braking torque target FD-1 or a first hydraulic pressure target FP-1.

In an embodiment, in combination with the preceding one and shown in FIG. 1a, the braking/traction system 2 of the vehicle 1 further comprises a further first dissipative braking torque actuation module 3′ operatively connected to at least one first axle F-A.

In an embodiment, the further first dissipative braking torque actuation module 3′ is with B-b-W technology, e.g., an electromechanical and/or electro-hydraulic actuator (EHA).

Therefore, the further first dissipative braking torque actuation module 3′, diagrammatically shown as a single block in the figures, comprises at least one electromechanical or electro-hydraulic actuator, at least one electronic control unit, at least one brake assembly (i.e., assembly of brake caliper, brake disc, pad(s)), at least one set of hydraulic lines to connect the aforesaid components together. The at least one electronic control unit of the further first dissipative braking torque actuation module 3′ is, for example, an appropriately configured hardware module or software logic present inside a main hardware module of the braking/traction system 2 or more in general inside a hardware module of the vehicle 1.

From a control point of view, the further first dissipative braking torque actuation module 3′ is configured to receive a further first dissipative braking torque target or a further first hydraulic pressure target.

As shown in FIG. 1a, in this embodiment, the at least one first dissipative braking torque actuation module 3 is operatively connected to the first wheel W-F1 (front left wheel) of the vehicle 1 and the further first dissipative braking torque actuation module 3′ is operatively connected to the second wheel W-F2 (front right wheel) of the vehicle 1.

In an embodiment, in combination with any of those described above in which the at least one second axle R-A of the vehicle 1 is provided and shown in FIGS. 1c and 1d, the braking/traction system 2 further comprises at least one second electric motor M2 operatively connected to the at least one second axle R-A (FIGS. 1c and 1d).

The at least one second electric motor M2 comprises a respective second electric motor control module C2.

The second electric motor control module C2 is configured to control the at least one second electric motor M2 to provide a regenerative braking or traction torque required by the system 100 based on a received target value.

The second electric motor control module C2 is, for example, an appropriately configured hardware module or software logic module present inside a main hardware module of the braking/traction system 2 or more in general inside a hardware module of the vehicle 1.

In this embodiment, the braking/traction system 2 of the vehicle 1 further comprises at least one second dissipative braking torque actuation module 4 operatively connected to the at least one second axle R-A.

In an embodiment, the at least one second dissipative braking torque actuation module 4 is with B-b-W technology, e.g., an electromechanical and/or electro-hydraulic actuator (EHA).

Therefore, the second dissipative braking torque actuation module 4, diagrammatically shown as a single block in the figures, comprises at least one electromechanical or electro-hydraulic actuator, at least one electronic control unit, at least one brake assembly (i.e., assembly of brake caliper, brake disc, pad(s)), at least one set of hydraulic lines to connect the aforesaid components together. The at least one electronic control unit of the second dissipative braking torque actuation module 4 is, for example, an appropriately configured hardware module or software logic present inside a main hardware module of the braking/traction system 2 or more in general inside a hardware module of the vehicle 1.

From a control point of view, the at least one second regenerative braking torque actuation module 4 is configured to receive a second dissipative braking FD-2 or hydraulic pressure FP-2 target.

According to a further embodiment (shown in FIGS. 1c and 1d), the braking/traction system 2 of the vehicle 1 further comprises a further second dissipative braking torque actuation module 4′ operatively connected to at least one second axle R-A.

In an embodiment, the further second dissipative braking torque actuation module 4′ is with B-b-W technology, e.g., an electromechanical and/or electro-hydraulic actuator (EHA).

Therefore, the further dissipative braking torque actuation module 4′, diagrammatically shown as a single block in the figures, also comprises at least one electromechanical or electro-hydraulic actuator, at least one electronic control unit, at least one brake assembly (i.e., assembly of brake caliper, brake disc, pad(s)), at least one set of hydraulic lines to connect the aforesaid components together. The at least one electronic control unit of the at least one second dissipative braking torque actuation module 4′ is, for example, an appropriately configured hardware module or software logic present inside a main hardware module of the braking/traction system 2 or more in general inside a hardware module of the vehicle 1.

From a control point of view, the further second regenerative braking torque actuation module 4′ is configured to receive a further second dissipative braking torque target or a further second hydraulic pressure target.

As shown in FIGS. 1c and 1d, in this embodiment, the at least one second dissipative braking torque actuation module 4 is operatively connected to the further first wheel W-R1 (rear left wheel) of the vehicle 1 and the further second dissipative braking torque actuation module 4′ is operatively connected to the further second wheel W-R2 (rear right wheel) of the vehicle 1.

According to a further embodiment (shown in FIG. 1d), the at least one first electric motor M1 is operatively connected to the first wheel W-F1 (front wheel).

In this embodiment, shown in FIG. 1d, the at least one first dissipative braking torque actuation module 3 is operatively connected to the first wheel W-F1.

In a further embodiment, in combination with the preceding one and also shown in FIG. 1d, the braking/traction system 2 of the vehicle 1 further comprises a further first electric motor M1′ operatively connected to the second wheel W-F2.

In this embodiment, the at least one first wheel W-F1 and the second wheel W-F2 are connected to the at least one first axle F-A, e.g., as the front left wheel (W-F1) and the front right wheel (W-F2).

In this embodiment, the further first electric motor M1′ comprises a respective further first electric motor control module C1′.

The further first electric motor control module C1′ is configured to control the further first electric motor M1′ to provide a regenerative braking or traction torque required by the system 100 based on a received target value.

The further first electric motor control module C1′ is, for example, an appropriately configured hardware module or software logic module present inside a main hardware module of the braking/traction system 2 or more in general inside a hardware module of the vehicle 1.

In an embodiment (shown in FIG. 1d), in combination with any of the preceding ones in which the at least one second axle R-A is present, the at least one second electric motor M2 is operatively connected to the further first wheel W-R1 (rear left wheel).

In a further embodiment, in combination with the preceding one and shown in FIG. 1d, the braking/traction system 2 of the vehicle 1 comprises a further second electric motor M2′ operatively connected to the further second wheel W-R2 (rear right wheel).

In this embodiment, the further first wheel W-F1 and the further second wheel W-F2 are connected to the at least one second axle R-A, e.g., as the rear left wheel (W-F1) and the rear right wheel (W-F2).

In this embodiment, the further second electric motor M2′ comprises a respective further second electric motor control module C2′.

The further second electric motor control module C2′ is configured to control the further second electric motor M2′ to provide a regenerative braking or traction torque required by the system 100 based on a received target value.

The further second electric motor control module C2′ is, for example, an appropriately configured hardware module or software logic module present inside a main hardware module of the braking/traction system 2 or more in general inside a hardware module of the vehicle 1.

In an embodiment, shown in FIGS. 1a and 1b, in combination with any of the preceding ones in which the at least one second electric motor M2 and/or the further second electric motor M2′ is not present and in which the at least one second axle R-A of the vehicle 1 is present, the braking/traction system 2 of the vehicle 1 comprises at least one second dissipative braking torque actuation module 4 operatively connected to the at least one second axle R-A.

In this embodiment, the at least one second dissipative braking torque actuation module 4 is a standard hydraulic actuator.

According to a further embodiment, in combination with the preceding one and shown in FIGS. 1a and 1b, the braking/traction system 2 of the vehicle 1 comprises a further second dissipative braking torque actuation module 4′ operatively connected to at least one second axle R-A.

In this embodiment, the second dissipative braking torque actuation module 4 is operatively connected to the further first wheel W-R1 (rear left wheel) of the vehicle 1 and the further second dissipative braking torque actuation module 4′ is operatively connected to the further second wheel W-R2 (rear right wheel) of the vehicle 1.

In this embodiment, the further second dissipative braking torque actuation module 4′ is a standard hydraulic actuator.

In addition to the embodiments described with reference to FIGS. 1a-1d, other combinations are possible in which the presence of at least one electric motor and at least one dissipative braking torque actuation module with Brake-by-Wire technology is provided on one or more axles and/or one or more wheel corners of the vehicle.

If there are axles and/or wheel corners of the vehicle in which no electric motors are provided, the respective dissipative braking torque actuation module can be of standard type, e.g., a standard hydraulic actuator, thus not with Brake-by-Wire technology.

The most general embodiment, for example shown in FIG. 1a, provides for the braking/traction system 2 comprising at least one electric motor and a dissipative braking torque actuation module with B-b-W technology on at least one axle or wheel corner of the vehicle 1.

Returning in general to FIGS. 1a-1d, the system 100, according to the present invention, comprises a vehicle control unit (VCU) 5 configured to receive a braking or traction request RF.

The braking or traction request RF can be imparted by a driver P1 by means of one or more pedals of the vehicle 1 (e.g., the brake pedal for a braking request or the accelerator pedal for a traction request) or automatically P2, e.g., by a vehicle driving assistance software logic, an automatic autonomous-driving/braking logic, and so on.

A braking request is preferably provided to the vehicle control unit 5 upon a processing performed by a stroke/pressure sensor of a brake pump (not shown in the figures) of the braking/traction system 2 of the vehicle 1.

A traction request is preferably provided to the vehicle control unit 5 upon a processing performed, for example, by a stroke sensor (not shown in the figures) from the vehicle 1.

The vehicle control unit 5 is configured to determine a braking or traction target value TG to be imparted to the vehicle 1, based on said braking or traction request RF.

For example, the vehicle control unit 5 is an appropriately configured electronic hardware module or software logic module present inside a main electronic hardware module of the braking/traction system 2 or more in general inside an electronic hardware module of the vehicle 1.

For example, the braking or traction target value TG is a torque target value expressed in Nm, e.g., 1000 Nm on the at least one first axle F-A (front axle) and 500 Nm on the at least one second axle R-A (rear axle) or 1500 Nm as an overall vehicle target value.

In this case, a braking balancing sub-module, described below with reference to an embodiment of the present invention, is also employed to distribute the overall vehicle target value to each axle and/or each vehicle corner.

According to a further example, the braking or traction target value TG can be a deceleration target value, e.g., −15 m/s2 as an overall vehicle target value.

In this case, the deceleration target value is converted to torque target value by a vehicle braking/traction control unit (described below) connected to the vehicle control unit 5 and a braking balancing sub-module, described below with reference to an embodiment of the present invention, is also employed to distribute the overall vehicle target value to each axle and/or each vehicle corner.

The system 100 further comprises a vehicle braking/traction control unit 6 operatively connected to said vehicle control unit 5.

For example, the vehicle braking/traction control unit 6 is an appropriately configured hardware module or software logic module present inside a main hardware module of the braking/traction system 2 or more in general inside a hardware module of the vehicle 1.

The vehicle braking/traction control unit 6 is configured to be operatively connected to the at least one first electric motor M1, of the braking/traction system 2 of vehicle 1, operatively connected to the at least one first axle F-A of the vehicle 1.

The vehicle braking/traction control unit 6 is configured to control the at least one first electric motor M1, thus the at least one first axle F-A.

In greater detail, in an embodiment, shown in FIGS. 1a-1d, the vehicle braking/traction control unit 6 is directly connectable to at least one first electric motor M1.

Moreover, the vehicle braking/traction control unit 6 is configured to be operatively connected to the at least one first dissipative braking torque actuation module 3, of the braking/traction system 2 of vehicle 1, operatively connected to the at least one first axle F-A.

The vehicle braking/traction control unit 6 is configured to control the at least one first dissipative braking torque actuation module 3.

In greater detail, in an embodiment, shown in FIGS. 1a-1d, the vehicle braking/traction control unit 6 is directly connectable to the at least one first dissipative braking torque actuation module 3.

Again with general reference to FIGS. 1a-1d, the system 100 further comprises a battery management unit 7 or BMS (Battery Management System) operatively connected to the vehicle braking/traction control unit 6.

For example, the battery management unit 7 is an appropriately configured hardware module or software logic module present inside a main hardware module of the braking/traction system 2 or more in general inside a hardware module of the vehicle 1.

The system 100 further comprises a battery pack 8 operatively connected to the vehicle braking/traction control unit 6 by means of the battery management unit 7.

The battery pack 8 is configured to store electricity, even in large quantities, during a braking phase of the vehicle 1, to be supplied to the at least one first electric motor M1 during a traction phase of the vehicle 1.

For example, the first battery pack 8 is either a battery pack of high-energy cells or a battery pack of high-energy cells and high-power cells.

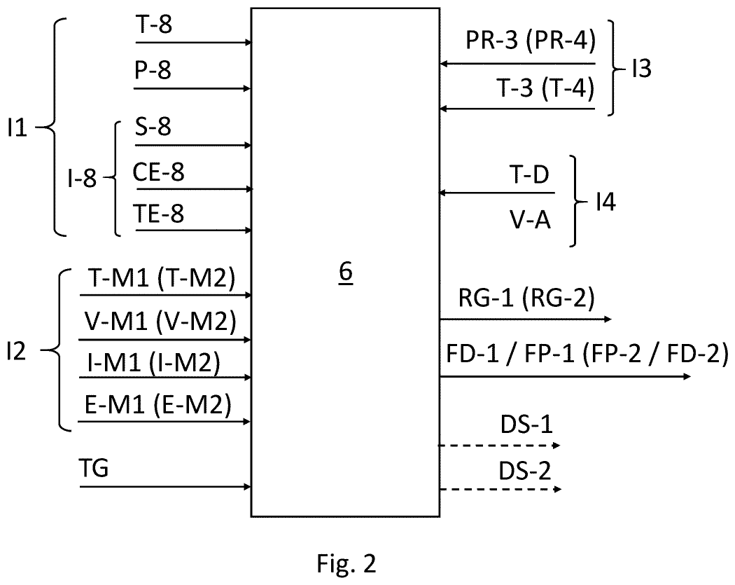

According to the present invention, from a functional point of view, referring now also to FIG. 2, the vehicle braking/traction control unit 6 is configured to receive the braking or traction target value TG to be imparted to the vehicle 1 determined by the vehicle control unit 5 of the vehicle 1 based on said braking or traction request RF.

The vehicle braking/traction control unit 6 is configured to receive first input information I1 representative of the battery pack 8.

In this respect, the battery management unit 7 is configured to provide the vehicle braking/traction control unit 6 with the first input information I1 representative of the battery pack 8.

The first input information I1 can comprise, for example, one or more of:
deliverable/regenerable maximum electrical power P-8 with the first battery pack 8;
operating temperature T-8 of the battery pack 8;
information I-8 representative of an operating condition of the battery pack 8, such as state of health (SOH) S-8 of the battery pack 8, electrical charge status CE-8 or simply state of charge (SOC) of the battery pack 8, electrical voltage value TE-8 of the battery pack 8, for example.

The vehicle braking/traction control unit 6 is further configured to receive second input information I2 representative of a regenerative braking or traction phase performed by the system 100 on the braking/traction system 2 of the vehicle 1 by means of the at least one electric motor M1.

In this case, the second input information I2 can comprise, for example, one or more of:
current temperature value T-M1 of the at least one first electric motor M1;
current rotation speed V-M1 of the at least one first electric motor M1;
current electric current value I-M1 of the at least one first electric motor M1;
current efficiency or yield value E-M1 of the at least one first electric motor M1.

The second input information I2 can be provided by respective sensors distributed in the braking/traction system 2 of the vehicle 1 (excluding the current efficiency or yield value E-M1 of the at least one first electric motor M1), and/or estimated by means of respective algorithms for estimating such quantities.

In this respect, according to different embodiments, such algorithms for estimating such quantities can reside in the vehicle control unit 5 and/or in an electric motor control module and/or in an electronic control unit present in a dissipative braking torque actuation module with B-b-W technology and/or in the vehicle braking/traction control unit 6.

Preferably, in the case of the second input information I2, such algorithms for estimating such quantities can reside in the vehicle control unit 5 and/or in each electric motor control module.

Therefore, the vehicle braking/traction control unit 6 is configured to receive the second input information I2 directly from an electric motor control module, from an electric motor control module by means of the vehicle control unit 5, directly from the vehicle control unit 5, and/or any combination of the preceding configurations.

According to further embodiments, in which the braking/traction system 2 of the vehicle 1 has multiple electric motors in addition to the at least one first electric motor M1, the vehicle braking/traction control unit 6 is further configured to receive second input information I2 representative of a regenerative braking or traction phase performed by the system 100 on the braking/traction system 2 of the vehicle 1 by means of each of such electric motors in addition to the at least one first electric motor M1 (e.g., if present, the second electric motor M2, the further first electric motor M1′, and the further second electric motor M2′).

In the embodiment in which there is also the second electric motor M2 operatively connected to the at least one second axle R-A in the braking/traction system 2 of the vehicle 1, the second input information I2 can further comprise, for example, one or more of:
current temperature value T-M2 of the second electric motor M2;
current rotation speed V-M2 of the second electric motor M2;
current electric current value I-M2 of the second electric motor M2;
current efficiency or yield value E-M2 of the second electric motor M2.

Returning in general to the present invention, the vehicle braking/traction control unit 6 is further configured to receive third input information I3 representative of a dissipative braking phase performed by the system 100 on the braking/traction system 2 of the vehicle 1 by means of the at least one first dissipative braking torque actuation module 3.

The third input information I3 can comprise, for example, one or more of:
a current hydraulic pressure value PR-3 of the at least one first dissipative braking torque actuation module 3;

a current temperature value T-3 of the at least one first dissipative braking torque actuation module 3.

The third input information I3 can be provided by respective sensors distributed in the braking/traction system 2 of the vehicle 1 and/or by the vehicle control unit 5, and/or estimated by means of respective algorithms for estimating such quantities.

In this respect, according to different embodiments, such algorithms for estimating such quantities can reside in the vehicle control unit 5 and/or in an electric motor control module and/or in an electronic control unit present in a dissipative braking torque actuation module with B-b-W technology and/or in the vehicle braking/traction control unit 6.

Preferably, in the case of the third input information I3, such algorithms for estimating such quantities can reside in the vehicle control unit 5 and/or in an electronic control unit present in a dissipative braking torque actuation module with B-b-W technology.

Therefore, the vehicle braking/traction control unit 6 is configured to receive the third input information I3 from the vehicle control unit 5 or an electronic control unit present in a dissipative braking torque actuation module with B-b-W technology according to any combination of the preceding configurations.

According to further embodiments, in which the braking/traction system 2 of the vehicle 1 has multiple dissipative braking torque actuation modules in addition to the at least one first dissipative braking torque actuation module 3, the vehicle braking/traction control unit 6 is further configured to receive third input information I3 representative of a regenerative braking or traction phase performed by the system 100 on the braking/traction system 2 of the vehicle 1 by means of each of such dissipative braking torque actuation modules in addition to the at least one first dissipative braking torque actuation module 3 (e.g., if present, the second dissipative braking torque actuation module 4, the further first dissipative braking torque actuation module 3′, and the further second dissipative braking torque actuation module 4′).

In the embodiment in which there is also the second actuation module 4 operatively connected to the at least one second axle R-A in the braking/traction system 2 of the vehicle 1, the third input information I3 can further comprise, for example, one or more of:
a current hydraulic pressure value PR-4 of the second dissipative braking torque actuation module 4;
a current temperature value T-4 of the second dissipative braking torque actuation module 4.

Returning in general to the present invention, the vehicle braking/traction control unit 6 is further configured to receive fourth input information I4 representative of an operating condition of the at least one first axle F-A or a vehicle corner connected to the at least one first axle F-A.

The fourth input information I4 can comprise, for example, one or more of:
current temperature T-D of a brake disc (not shown in the figures) operatively connected to a wheel of the at least one first axle F-A to which the dissipative braking torque is imparted by means of the at least one first dissipative braking torque actuation module 3;
current rotation speed V-A of the at least one first axle F-A or a vehicle corner connected to the at least one first axle F-A (thus of the first wheel W-F1 and the second wheel W-F2).

The fourth input information I4 can be provided by respective sensors distributed in the braking/traction system 2 of the vehicle 1 and/or estimated by means of respective algorithms for estimating such quantities.

In this respect, according to different embodiments, such algorithms for estimating such quantities can reside in the vehicle control unit 5 and/or in an electric motor control module and/or in an electronic control unit present in a dissipative braking torque actuation module with B-b-W technology and/or in the vehicle braking/traction control unit 6.

Preferably, in the case of the fourth input information I4, such algorithms for estimating such quantities can reside in the vehicle control unit 5 and/or in an electronic control unit present in a dissipative braking torque actuation module with B-b-W technology.

Therefore, the vehicle braking/traction control unit 6 is configured to receive the fourth input information I4 from the vehicle control unit 5 or an electronic control unit present in a dissipative braking torque actuation module with B-b-W technology according to any combination of the preceding configurations.

According to further embodiments, in which multiple axles are present in the vehicle 1 in addition to the at least one first axle F-A, the vehicle braking/traction control unit 6 is further configured to receive fourth input information I4 representative of each axle or each vehicle corner connected to an axle of the vehicle 1 (e.g., if present, the at least one second axle R-A).

According to a further embodiment, in which the at least one second axle R-A is also present in the vehicle 1 in addition to the at least one first axle F-A, the vehicle braking/traction control unit 6 is further configured to receive fourth input information I4 representative of an operating condition of the at least one second axle R-A or a vehicle corner connected to the at least one second axle R-A.

In the embodiment in which the at least one second axle R-A is also present in the vehicle 1, the fourth input information I4 can further comprise, for example, one or more of:
current temperature T-D′ of a brake disc (not shown in the figures) operatively connected to a wheel of the at least one second axle R-A to which the dissipative braking torque is imparted by means of the at least one second dissipative braking torque actuation module 4;
current rotation speed V-A′ of the at least one second axle R-A or a vehicle corner connected to the at least one second axle R-A (thus of the further first wheel W-R1 and the further second wheel W-R2).

Turning back in general to the present invention, the vehicle braking/traction control unit 6 is configured to determine a first regenerative braking torque or traction target value RG-1 (e.g., expressed in Nm) to be imparted to the vehicle 1 by means of the at least one first electric motor M1, based on the braking or traction target value TG to be imparted to the vehicle 1, the first input information I1, the second input information I2, the third input information I3, and the fourth input information I4.

The vehicle braking/traction control unit 6 is further configured to determine a first dissipative braking torque target value FD-1 (e.g., expressed in Nm) or a first hydraulic pressure target value FP-1 (e.g., expressed in bars) to be imparted to the vehicle 1 by means of the at least one first dissipative braking torque actuation module 3, based on the braking or traction target value TG to be imparted to the vehicle 1, the first input information I1, the second input information I2, the third input information I3, and the fourth input information I4.

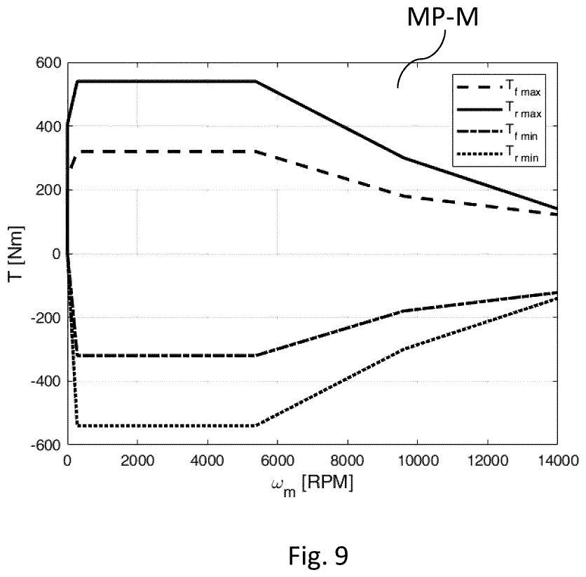

It should be noted that an example of determining the first regenerative braking torque or traction target value RG-1 and determination of the first dissipative braking torque target value FD-1 or the first hydraulic pressure target value FP-1 is described below in a related APPENDIX 1 with reference to FIG. 9.

It should be noted that “a first regenerative braking torque or traction target value to be imparted to the vehicle” means “a first regenerative braking torque or traction target value to be imparted to the at least one first axle or to at least one vehicle corner of the at least one first axle”.

Moreover, it should be noted that “a first dissipative braking torque target value or a first hydraulic pressure target value to be imparted to the vehicle” means “a first dissipative braking torque target value or a first hydraulic pressure target value to be imparted to the at least one first axle or to at least one vehicle corner of the at least one first axle”.

It should be noted that in an embodiment, in which the at least one second axle R-A, in addition to the at least one first axle F-A, is present in the vehicle 1, and in which the at least one second electric motor M2 operatively connected to the at least one second axle R-A, in addition to the at least one first electric motor M1 operatively connected to the at least one first axle F-A is present, the vehicle braking/traction control unit 6 is configured to determine the first regenerative braking torque or traction target value RG-1 to be imparted to the vehicle 1, to the at least one first axle F-A or vehicle corner connected to the at least one first axle F-A, by means of the at least one first electric motor M1, and a second regenerative braking torque or traction target value RG-2 to be imparted to vehicle 1, to the at least one second axle R-A or vehicle corner connected to the at least one second axle R-A, by means of the at least one second electric motor M2, based on the braking or traction target value TG to be imparted to the vehicle 1, the first input information I1, the second input information I2 representative of a regenerative braking or traction phase performed by the system 100 on the braking/traction system 2 of the vehicle 1 by means of the at least one first electric motor M1, the second input information I2 representative of a regenerative braking or traction phase performed by the system 100 on the braking/traction system 2 of the vehicle 1 by means of the at least one second electric motor M2, the third input information I3 representative of a dissipative braking phase performed by the system 100 on the braking/traction system 2 of the vehicle 1 by means of the first dissipative braking torque actuation module 3, the third input information I3 representative of a dissipative braking phase performed by the system 100 on the braking/traction system 2 of the vehicle 1 by means of the second dissipative braking torque actuation module 4, the fourth input information I4 representative of an operating condition of the at least one first axle F-A or vehicle corner connected to the at least one first axle F-A, and the fourth input information I4 representative of an operating condition of the at least one second axle R-A or vehicle corner connected to the at least one second axle R-A.

Moreover, in this embodiment, the vehicle braking/traction control unit 6 is configured to determine a first dissipative braking torque target value FD-1 or a first hydraulic pressure target value FP-1 to be imparted to the vehicle 1 by means of the first dissipative braking torque actuation module 3 and a second dissipative braking torque target value FD-2 or a second hydraulic pressure target value FP-2 to be imparted to the vehicle 1 by means of the second dissipative braking torque actuation module 4, based on the braking or traction target value TG to be imparted to the vehicle 1, the first input information I1, the second input information I2 representative of a regenerative braking or traction phase performed by the system 100 on the braking/traction system 2 of the vehicle 1 by means of the at least one first electric motor M1, the second input information I2 representative of a regenerative braking or traction phase performed by the system 100 on the braking/traction system 2 of the vehicle 1 by means of the at least one second electric motor M2, the third input information I3 representative of a dissipative braking phase performed by the system 100 on the braking/traction system 2 of the vehicle 1 by means of the first dissipative braking torque actuation module 3, the third input information I3 representative of a dissipative braking phase performed by the system 100 on the braking/traction system 2 of the vehicle 1 by means of the second dissipative braking torque actuation module 4, the fourth input information I4 representative of an operating condition of the at least one first axle F-A or vehicle corner connected to the at least one first axle F-A, and the fourth input information I4 representative of an operating condition of the at least one second axle R-A or vehicle corner connected to the at least one second axle R-A.

It should be noted that the embodiment just described is also applicable to “two-wheeled” vehicles, i.e., a vehicle in which a first (front) wheel is connected to at least one first axle F-A (front axle) and a second (rear) wheel is connected to at least one second axle R-A (rear axle). It should be noted that, from an architectural point of view, in the case of a two-wheeled vehicle, the braking system 2 of the vehicle 1 has a first brake pump connected to the front axle of the vehicle and a second brake pump connected to the rear axle of the vehicle.

In an embodiment, the braking or traction target value TG to be imparted to the vehicle 1 received from the vehicle control unit 5 is a single braking or traction target value to be imparted to an axle and/or a vehicle corner.

In an embodiment, alternative to the preceding one, the braking or traction target value TG to be imparted to the vehicle 1 received from the vehicle control unit 5 is an overall braking or traction target value to be imparted to the vehicle 1.

In this embodiment, the vehicle braking/traction control unit 6 is configured to determine, based on the received overall braking or traction target value to be imparted to the vehicle 1, respective regenerative braking torque or traction target values RG-1 and respective dissipative braking torque target values FD-1 or respective hydraulic pressure target values FP-1 to be imparted to each axle and/or each vehicle corner.

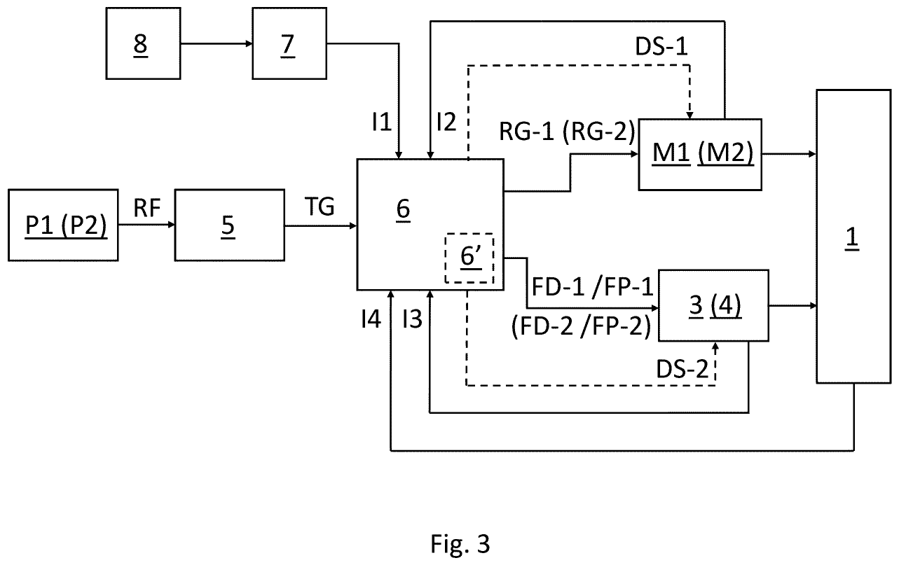

In an embodiment, in combination with the preceding one, the vehicle braking/traction control unit 6 comprises a braking balancing sub-module 6′ (shown in dashed lines in FIG. 3) configured to determine, based on the received overall braking or traction target value to be imparted to the vehicle 1, respective regenerative braking torque or traction target values RG-1 and respective dissipative braking torque target values FD-1 or respective hydraulic pressure target values FP-1 to be imparted to each axle and/or each vehicle corner.

It should be noted that an example of the braking balancing performed by the braking balancing sub-module 6′ is described below in a related APPENDIX 2.

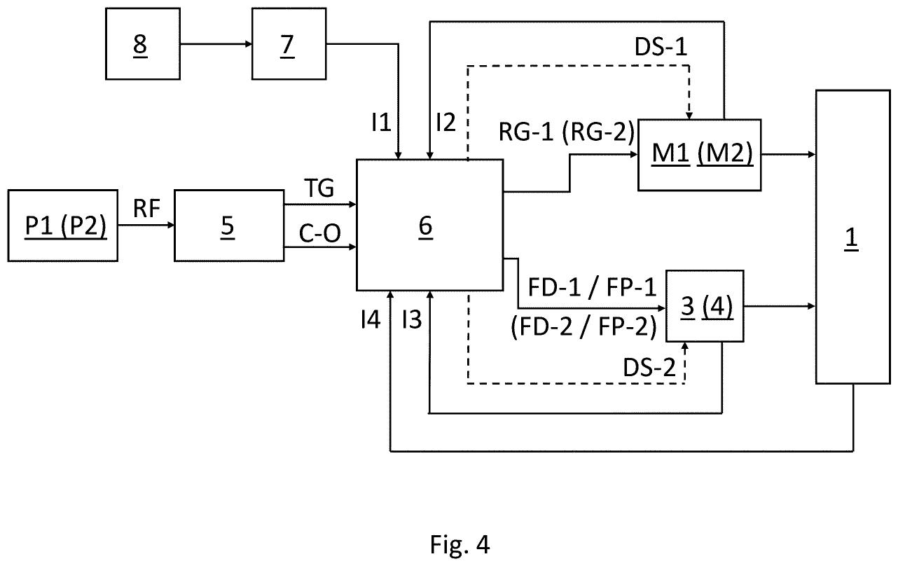

According to an embodiment, in combination with any of the preceding ones and shown in FIG. 4, the vehicle braking/traction control unit 6 is further configured to receive at least one piece of information C—O representative of an operating condition of the vehicle 1.

“Information representative of an operating condition of the vehicle” means the set of one or more operating parameters of the vehicle 1, such as speed, acceleration and/or deceleration, and so on.

In this respect, the at least one piece of information C—O representative of an operating condition of the vehicle 1 can comprise, for example, one or more of:
current speed of the vehicle 1;
current acceleration of the vehicle 1;
current deceleration of the vehicle 1;
grip of the vehicle 1 on the road surface.

The at least one piece of information C—O representative of an operating condition of vehicle 1 can be provided by one or more sensors distributed in vehicle 1 and/or determined by the vehicle control unit 5.

In this embodiment, the vehicle braking/traction control unit 6 is configured to determine the first regenerative braking torque or traction target value RG-1 to be imparted to the vehicle 1 by means of the at least one first electric motor M1 also based on the at least one piece of information C—O representative of an operating condition of the vehicle 1.

In this embodiment, the vehicle braking/traction control unit 6 is further configured to determine a first dissipative braking torque target value FD-1 or a first hydraulic pressure target value FP-1 to be imparted to the vehicle 1 by means of the at least one first dissipative braking torque actuation module 3, also based on the at least one piece of information C—O representative of an operating condition of the vehicle 1.

In an embodiment, in combination with the preceding one, the vehicle braking/traction control unit 6 is configured to store the at least one piece of information C—O representative of an operating condition of the vehicle 1 previously received on a case-by-case basis and compare the received at least one piece of information C—O representative of an operating condition of the vehicle 1 with the information C—O representative of an operating condition of the vehicle 1 previously stored to identify the most similar ones and thus improve the performance of the system 100 based on the previously taken actions.

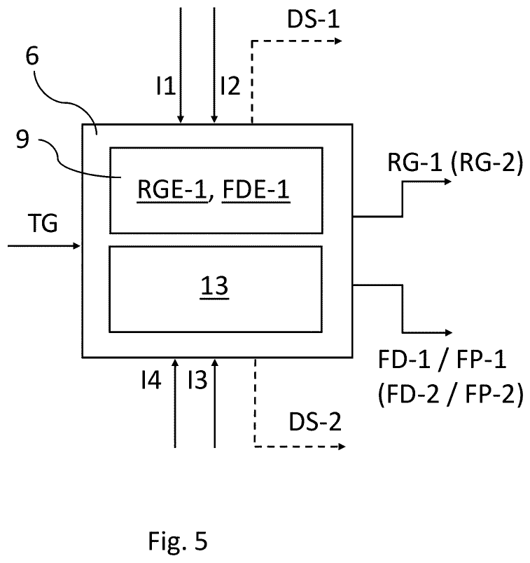

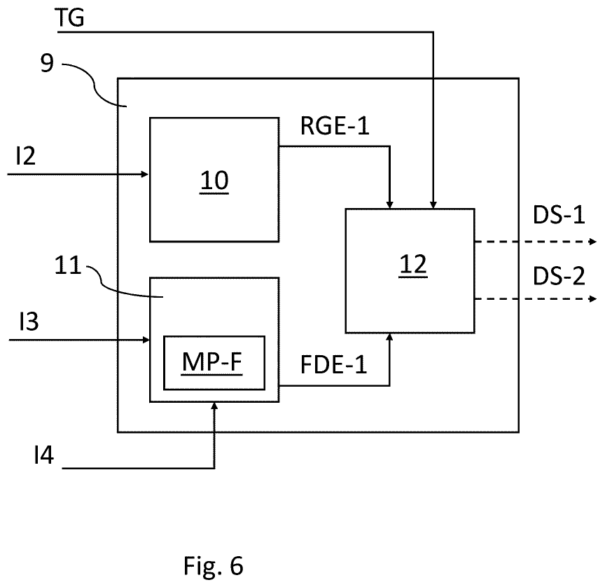

According to an embodiment, in combination with any of the preceding ones, also referring now to FIGS. 5 and 6, the vehicle braking/traction control unit 6 comprises a first monitoring module 9 configured to switch the system 100 to a safe condition in case of an anomaly detected in the system 100.

“Anomaly” of the system 100 means a discrepancy beyond a set reference threshold between the braking or traction target value TG to be imparted to the vehicle 1 received from the vehicle braking/traction control unit 6 and a sum between an estimated regenerative braking torque or traction value RGE-1 imparted to the vehicle 1 by the at least one first electric motor M1 and an estimated dissipative braking torque value FDE-1 imparted to the vehicle 1 by means of the at least one first dissipative braking torque actuation module 3.

In greater detail, with particular reference to FIG. 6, in order to switch the system 100 to a safe condition, the first monitoring module 9 comprises a first regenerative braking torque or traction estimation sub-module 10 configured to estimate the estimated regenerative braking torque or traction value RGE-1 imparted to the vehicle 1 by means of the at least one first electric motor M1, based on the second input information I2 representative of a regenerative braking or traction phase performed by the system 100 on the braking/traction system 2 of the vehicle 1 by means of the at least one electric motor M1 and a respective motor friction map.

Moreover, the first monitoring module 9 comprises a second dissipative braking torque estimation sub-module 11 configured to estimate the estimated dissipative braking torque value FDE-1 imparted to the vehicle 1 by means of the at least one first dissipative braking torque actuation module 3, based on the third input information I3 representative of a dissipative braking phase performed by the system 100 on the braking/traction system 2 of the vehicle 1 by means of the at least one first dissipative braking torque actuation module 3, the fourth input information I4 representative of an operating condition of the at least one first axle F-A or a vehicle corner connected to the at least one first axle F-A, and a pad/brake friction map MP-F.

The first monitoring module 9 further comprises a third comparison sub-module 12 configured to compare a difference between the braking or traction target value TG to be imparted to the vehicle 1 received from the vehicle braking/traction control unit 6 and a sum between the estimated regenerative braking torque or traction value RGE-1 imparted to the vehicle 1 by means of the at least one first electric motor M1 and the estimated dissipative braking torque value FDE-1 imparted to the vehicle 1 by means of the at least one first dissipative braking torque actuation module 3 with a set reference threshold.

The first monitoring module 9, if such a difference is greater than the set reference threshold, is configured to disable both the at least one first electric motor M1 and the at least one first dissipative braking torque actuation module 3 by sending a first disabling signal DS-1 to the at least one first electric motor M1 and a second disabling signal DS-2 to the at least one first dissipative braking torque actuation module 3, respectively.

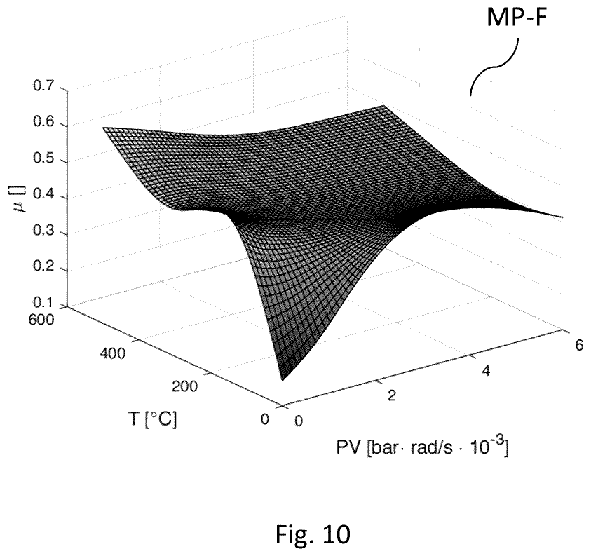

It should be noted that an example of monitoring performed by the first monitoring module 9 is described below in a related APPENDIX 3 with reference to FIG. 10.

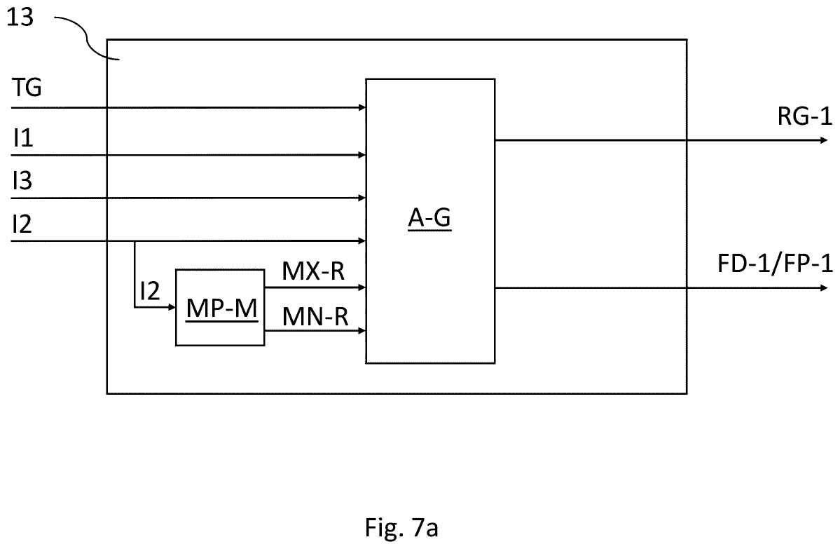

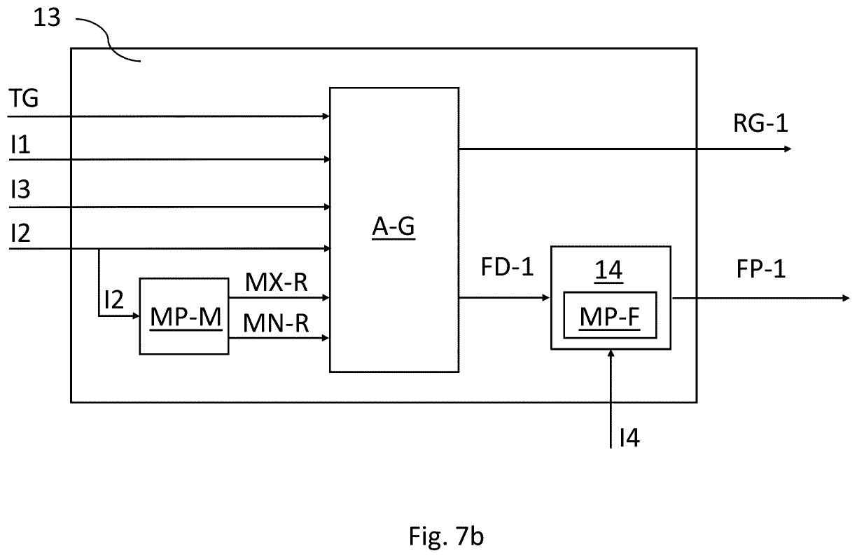

According to an embodiment, in combination with any of the preceding ones, again referring also to FIGS. 5, 7a and 7b, the vehicle braking/traction control unit 6 comprises a second control module 13 configured, by means of an appropriate algorithm AG, to determine the regenerative braking torque or traction value RG-1 to be imparted to the vehicle 1 by means of the at least one first electric motor M1 and the dissipative braking torque value FD-1 (FIG. 7a) or hydraulic pressure value FP-1 (FIG. 7b) to be imparted to the vehicle 1 by means of the at least one first dissipative braking torque actuation module 3.

According to an embodiment, in combination with the preceding one and shown in FIGS. 7a and 7b, the second control module 13 is configured to determine, employing a respective motor friction map MP-M, a maximum regenerative braking torque or traction value MX-R and a minimum regenerative braking torque or traction value MN—R based on the second input information I2 representative of a regenerative braking or traction phase performed by the system 100 on the braking/traction system 2 of the vehicle 1 by means of the at least one first electric motor M1.

According to an embodiment, in combination with any of the preceding ones in which the second control module 13 is provided and shown in FIG. 7b, the second control module 13 further comprises a friction map reversal sub-module 14 configured to determine, employing a respective pad/brake friction map MP-F, a hydraulic pressure value FP-1 to be imparted to the vehicle 1 by means of the at least one first dissipative braking torque actuation module 3 based on the first dissipative braking torque target value FD-1 to be imparted to the vehicle 1 by means of the at least one first dissipative braking torque actuation module 3 and the fourth input information I4 representative of an operating condition of the at least one first axle F-A or a vehicle corner connected to the at least one first axle F-A.

It should be noted that an example of determining a hydraulic pressure value FP-1 to be imparted to the vehicle 1 performed by the friction map reversal sub-module 14 is described below in a related APPENDIX 4.

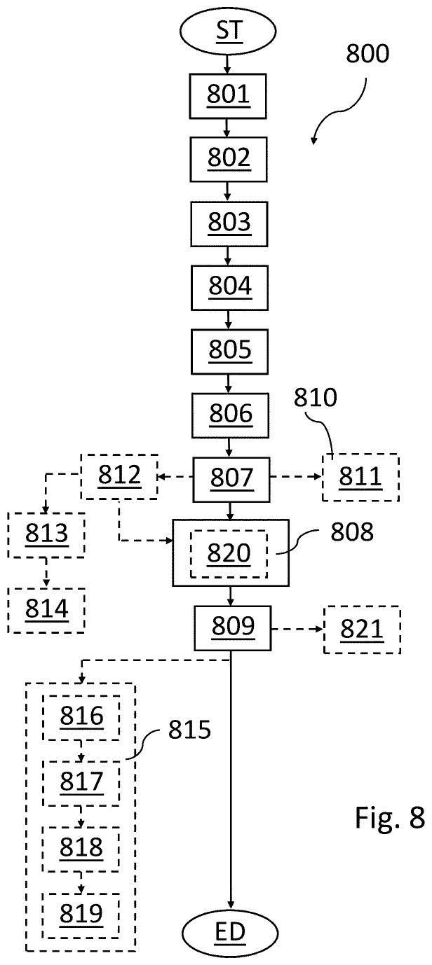

Referring now to the aforesaid figures and to the block diagram in FIG. 8, a method 800 of controlling braking/traction of an electric or hybrid vehicle is described, hereinafter also referred to as a control method only or simply method, according to the present invention.

It should be noted that the components and information mentioned below with the description of the method have already been described above with reference to the system 100 and therefore will not be repeated for brevity.

The method 800 comprises a symbolic step of starting ST.

The method 800 comprises a step of receiving 801, by a vehicle control unit 5, a braking or traction request RF.

The method 800 further comprises a step of determining 802, by the vehicle control unit 5, a braking or traction target value TG be imparted to the vehicle 1, based on said braking or traction request RF.

The method 800 further comprises a step of receiving 803, by a vehicle braking/traction control unit 6 operatively connected to said vehicle control unit 5, the braking or traction target value TG to be imparted to the vehicle 1 determined by the vehicle control unit 5 based on said braking or traction request RF.

The method 800 further comprises a step of receiving 804, by the vehicle braking/traction control unit 6, first input information I1 representative of a battery pack 8 operatively connected to the vehicle braking/traction control unit 6.

The first input information I1 representative of the battery pack 8 was described and defined above.

The battery pack 8 is configured to store electricity during a braking phase of the vehicle 1 to be supplied to at least one first electric motor M1, of a braking/traction system 2 of the vehicle 1, operatively connected to at least one first axle F-A of the vehicle 1, during a traction phase of the vehicle 1.

The vehicle braking/traction control unit 6 is operatively connected to the at least one first electric motor M1.

The vehicle braking/traction control unit 6 is configured to control the at least one first electric motor M1.

The method 800 further comprises a step of receiving 805, by the vehicle braking/traction control unit 6, second input information I2 representative of a regenerative braking or traction phase performed by the system 100 on the braking/traction system 2 of the vehicle 1 by means of the at least one first electric motor M1.

Such second input information I2 was described and defined above.

The method 800 further comprises a step of receiving 806, by the vehicle braking/traction control unit 6, third input information I3 representative of a regenerative braking or traction phase performed by the system 100 on the braking/traction system 2 of the vehicle 1 by means of at least one first dissipative braking torque actuation module 3 of the braking/traction system 2 of the vehicle 1.

The third input information I3 was described and defined above.

The vehicle braking/traction control unit 6 is operatively connected to the at least one first dissipative braking torque actuation module 3.

The vehicle braking/traction control unit 6 is configured to control the at least one first dissipative braking torque actuation module 3.

The method 800 further comprises a step of receiving 807, by the vehicle braking/traction control unit 6, fourth input information I4 representative of an operating condition of the at least one first axle F-A or a vehicle corner connected to the at least one first axle F-A.

The fourth input information I4 was described and defined above.

The method 800 further comprises a step of determining 808, by the vehicle braking/traction control unit 6, a first regenerative braking torque or traction target value RG-1 to be imparted to the vehicle 1 by means of the at least one first electric motor M1, based on the braking or traction target value TG to be imparted to the vehicle 1, the first input information I1, the second input information I2, the third input information I3, and the fourth input information I4.

Moreover, the method 800 further comprises a step of determining 809, by the vehicle braking/traction control unit 6, a first dissipative braking torque target value FD-1 or a first hydraulic pressure target value FP-1 to be imparted to the vehicle 1 by means of the at least one first dissipative braking torque actuation module 3, based on the braking or traction target value TG to be imparted to the vehicle 1, the first input information I1, the second input information I2, the third input information I3, and the fourth input information I4.

The definitions of “a first regenerative braking torque or traction target value to be imparted to the vehicle” and of “a first dissipative braking torque target value or a first hydraulic pressure target value to be imparted to the vehicle” were given above.

In an embodiment, the braking or traction target value TG to be imparted to the vehicle 1 received from the vehicle control unit 5 is a single braking or traction target value to be imparted to an axle and/or a vehicle corner.

In an embodiment, alternative to the preceding one, the braking or traction target value TG to be imparted to the vehicle 1 received from the vehicle control unit 5 is an overall braking or traction target value to be imparted to the vehicle 1.

In this embodiment, shown in dashed lines in FIG. 8, the method 800 comprises a step of determining 810, by the vehicle braking/traction control unit 6, based on the received overall braking or traction target value to be imparted to the vehicle 1, respective regenerative braking torque or traction target values and respective dissipative braking torque target values FD-1 or respective hydraulic pressure target values FP-1 to be imparted to each axle and/or each vehicle corner.

In an embodiment, in combination with the preceding one and shown in dashed lines in FIG. 8, the step of determining 810 respective regenerative braking torque or traction target values and respective dissipative braking torque target values FD-1 or respective hydraulic pressure target values FP-1 to be imparted to each axle and/or each vehicle corner comprises a step of determining 811, by a braking balancing sub-module 6′ (shown in dashed lines in FIG. 3) of the vehicle braking/traction control unit 6, based on the received overall braking or traction target value to be imparted to the vehicle 1, the respective regenerative braking torque or traction target values RG-1 and respective dissipative braking torque target values FD-1 or respective hydraulic pressure target values FP-1 to be imparted to each axle and/or each vehicle corner.

According to an embodiment, in combination with any of the preceding ones and shown in dashed lines in FIG. 8, the method 800 further comprises a step of receiving 812, by the vehicle braking/traction control unit 6, at least one piece of information C—O representative of an operating condition of the vehicle 1.

The at least one piece of information C—O representative of an operating condition of the vehicle was defined above.

In this embodiment, the first regenerative braking torque or traction target value RG-1 to be imparted to the vehicle 1 by means of the at least one first electric motor M1 is also determined, by the vehicle braking/traction control unit 6, based on the at least one piece of information C—O representative of an operating condition of the vehicle 1.

In this embodiment, the first dissipative braking torque target value FD-1 or the first hydraulic pressure target value FP-1 to be imparted to the vehicle 1 by means of the at least one first dissipative braking torque actuation module 3 is also determined, by the vehicle braking/traction control unit 6, based on the at least one piece of information C—O representative of an operating condition of the vehicle 1.

According to an embodiment, in combination with the preceding one and shown in dashed lines in FIG. 8, the method 800 further comprises steps of:
storing 813, by the vehicle braking/traction control unit 6, the at least one piece of information C—O representative of an operating condition of the vehicle 1 previously received on a case-by-case basis;
comparing 814, by the vehicle braking/traction control unit 6, the received at least one piece of information C—O representative of an operating condition of the vehicle 1 with the information C—O representative of an operating condition of the vehicle 1 previously stored to identify the most similar ones and thus improve the performance of the method 800 based on the previously taken actions.

According to an embodiment, in combination with any of the preceding ones, shown in dashed lines in FIG. 8, the method 800 comprises a step of switching 815, by a first monitoring module 9 of the vehicle braking/traction control unit 6, the system 100 to a safe condition in case of an anomaly detected in the system 100 for controlling the braking/traction of the electric or hybrid vehicle 1.

The definition of “anomaly” was given above.

In greater detail, the step of switching 815 the system 100 to a safe condition comprises a step of estimating 816, by a first regenerative braking torque or traction estimation sub-module 10 of the first monitoring module 9, an estimated regenerative braking torque or traction value RGE-1 imparted to the vehicle 1 by means of the at least one first electric motor M1, based on the second input information I2 representative of a regenerative braking or traction phase performed by the system 100 on the braking/traction system 2 of the vehicle 1 by means of the at least one electric motor M1 and a respective motor friction map.

Moreover, in this embodiment, the step of switching 815 the system 100 to a safe condition comprises a step of estimating 817, by a second dissipative braking torque estimation sub-module 11 of the first monitoring module 9, an estimated dissipative braking torque value FDE-1 imparted to the vehicle 1 by means of the at least one first dissipative braking torque actuation module 3, based on the third input information I3 representative of a dissipative braking phase performed by the system 100 on the braking/traction system 2 of the vehicle 1 by means of the at least one first dissipative braking torque actuation module 3, the fourth input information I4 representative of an operating condition of the at least one first axle F-A or a vehicle corner connected to the at least one first axle F-A, and a pad/brake friction map MP-F.

Moreover, in this embodiment, the step of switching 815 the system 100 to a safe condition comprises a step of comparing 818, by a third comparison sub-module 12 of the first monitoring module 9, a difference between the braking or traction target value TG to be imparted to the vehicle 1 received from the vehicle braking/traction control unit 6 and a sum between the estimated regenerative braking torque or traction value RGE-1 imparted to the vehicle 1 by the at least one first electric motor M1 and the estimated dissipative braking torque value FDE-1 imparted to the vehicle 1 by means of the at least one first dissipative braking torque actuation module 3 with a set reference threshold.

Moreover, in this embodiment, the step of switching 815 the system 100 to a safe condition comprises a step of disabling 819, by the at least one first monitoring module 9, if such a difference is greater than the set reference threshold, both the at least one first electric motor M1 and the at least one first dissipative braking torque actuation module 3 by sending a first disabling signal DS-1 to the at least one first electric motor M1 and a second disabling signal DS-2 to the at least one first dissipative braking torque actuation module 3, respectively.

According to an embodiment, in combination with any of the preceding ones, the step of determining 808 the first regenerative braking torque or traction target value RG-1 to be imparted to the vehicle 1 by means of the at least one first electric motor M1 and the step of determining 809 the first dissipative braking torque value FD-1 or the hydraulic pressure value FP-1 to be imparted to the vehicle 1 by means of the at least one first dissipative braking torque actuation module 3 are performed, by means of an appropriate algorithm AG, by a second control module 13 of the vehicle braking/traction control unit 6.

In an embodiment, shown in dashed line in FIG. 8, in combination with any of the preceding ones and after the step of receiving 805 second input information I2 representative of a regenerative braking or traction phase performed by the system 100 on the braking/traction system 2 of the vehicle 1 by means of the at least one first electric motor M1, the step of determining 808 the first regenerative braking torque or traction target value RG-1 to be imparted to the vehicle 1 by means of the at least one first electric motor M1 comprises a step of determining 820, by the second control module 13, employing a respective motor friction map MP-M, a maximum regenerative braking torque or traction value MX-R and a minimum regenerative braking torque or traction value MN-R based on the second input information I2 representative of a regenerative braking or traction phase performed on the braking/traction system 2 of the vehicle 1 by means of the at least one first electric motor M1.

In an embodiment, in combination with any of the preceding ones in which the second control module 13 is provided and shown in dashed lines in FIG. 8, the method 800 comprises a step of determining 821, by a friction map reversal sub-module 14 of the second control module 13, employing a respective pad/brake friction map MP-F, a hydraulic pressure value FP-1 to be imparted to the vehicle 1 by means of the at least one first dissipative braking torque actuation module 3, based on the first dissipative braking torque target value FD-1 to be imparted to the vehicle 1 by means of the at least one first dissipative braking torque actuation module 3 and the fourth input information I4 representative of an operating condition of the at least one first axle F-A or a vehicle corner connected to the at least one first axle F-A.

An example of operation of the system 100 for controlling the braking/traction of an electric or hybrid vehicle is now described with reference to the most general embodiment, shown in FIG. 1, in which vehicle 1 comprises at least one first axle F-A and the braking/traction system 2 of the vehicle 1 comprises the at least one first electric motor M1 operatively connected to the at least one first axle F-A and the at least one first dissipative braking torque actuation module 3 operatively connected to the at least one first axle F-A.

A vehicle control unit 5 receives from a driver P1 a braking or traction request RF and determines a braking or traction target value TG be imparted to the vehicle 1, based on said braking or traction request RF.

A vehicle braking/traction control unit 6 operatively connected to said vehicle control unit 5 receives the braking or traction target value TG to be imparted to the vehicle 1 determined by the vehicle control unit 5 based on said braking or traction request RF.

The vehicle braking/traction control unit 6 receives first input information I1 representative of a battery pack 8 operatively connected to the vehicle braking/traction control unit 6.

The first input information I1 representative of the battery pack 8 was described and defined above.

The battery pack 8 is configured to store electricity during a braking phase of the vehicle 1 to be supplied to the at least one first electric motor M1 of the braking/traction system 2 of the vehicle 1, operatively connected to the at least one first axle F-A of the vehicle 1, during a traction phase of the vehicle 1.

The vehicle braking/traction control unit 6 is operatively connected to the at least one first electric motor M1 and configured to control the at least one first electric motor M1.

The vehicle braking/traction control unit 6 receives second input information I2 representative of a regenerative braking or traction phase performed by the system 100 on the braking/traction system 2 of the vehicle 1 by means of the at least one first electric motor M1.

The second input information I2 was described and defined above.

The vehicle braking/traction control unit 6 receives third input information I3 representative of a dissipative braking phase performed by the system 100 on the braking/traction system 2 of the vehicle 1 by means of the at least one first dissipative braking torque actuation module 3 of the braking/traction system 2 of the vehicle 1.

The third input information I3 was described and defined above.

The vehicle braking/traction control unit 6 is operatively connected to the at least one first dissipative braking torque actuation module 3 and is configured to control the at least one first dissipative braking torque actuation module 3.

The vehicle braking/traction control unit 6 receives fourth input information I4 representative of an operating condition of the at least one first axle F-A.

The fourth input information I4 was described and defined above.

The vehicle braking/traction control unit 6 determines a first regenerative braking torque or traction target value RG-1 to be imparted to the vehicle 1 (to the at least one first axle F-A) by means of the at least one first electric motor M1, based on the braking or traction target value TG to be imparted to the vehicle 1, the first input information I1, the second input information I2, the third input information I3, and the fourth input information I4.

Moreover, the vehicle braking/traction control unit 6 determines a first dissipative braking torque target value FD-1 to be imparted to the vehicle 1 (to the at least one first axle F-A) by means of the at least one first dissipative braking torque actuation module 3, based on the braking or traction target value TG to be imparted to the vehicle 1, the first input information I1, the second input information I2, the third input information I3, and the fourth input information I4.

As can be appreciated, the object of the present invention is fully achieved.

Indeed, the system and method of the present invention allow improving, from a performance point of view, an architecture in which the vehicle control unit (VCU) is the only unit adapted to perform the operations, including the braking/traction control operations of the electric or hybrid vehicle.

Indeed, in the system and method of the present invention, the vehicle control unit (VCU) is relieved of several operations that are delegated to the vehicle braking/traction control unit.

In addition to reducing the implementation and computation burden on the vehicle control unit (VCU), a further advantage is the provision of an integrated motor+brake module which, developed by a single manufacturer, allows implementing and managing in a coordinated manner the pad/brake friction maps and motor friction maps of the two systems for generating a regenerative braking torque or traction and a dissipative braking torque, respectively, thus improving system efficiency and performance and achieving finer control of energy recovery and torque delivery.

The system and method according to the present invention considers all components of the braking/traction system and of the vehicle in general, i.e., actuators and battery pack, in one step only, thus achieving improved performance.

Moreover, the proper operation of the brake and powertrain systems can be monitored by switching to safe mode in case of failure (if possible).

Optionally, the vehicle state history can be utilized to improve the performance thereof.

Optionally, the braking balancing function can also be integrated.

In brief, the system and method of the present invention allow perfectly integrating electric motor and friction brakes.

The method manages the electrical (positive and negative) and frictional (negative) braking torques of at least one axle or vehicle corner.

The system and method of the present invention:
receive the target braking torque value of the axle/vehicle corner from the vehicle control unit (VCU), and then, based on the battery, brake and motor information, are capable of determining the regenerative braking torque and dissipative braking torque target values;
optimize braking and regeneration performance;
manage the traction control according to the torque target value VCU;
have a holistic blending strategy;
reduce the workload of the vehicle control unit (VCU);
allow reducing time/money/fatigue for teams (less design development, less coding, less testing);
control the brakes and motors;
optionally, improve performance thereof using the vehicle states.

Those skilled in the art may make changes and adaptations to the embodiments of the system and method described above or can replace elements with others which are functionally equivalent in order to meet contingent needs without departing from the scope of the following claims. Each of the features described above as belonging to a possible embodiment can be implemented irrespective of the other embodiments described.

### APPENDIX 1

### Example of Determining the First Regenerative Braking Torque or Traction Target Value RG-1 and Determining the First Dissipative Braking Torque Target Value FD-1 or the First Hydraulic Pressure Target Value FP-1

### In General

### Step 1

Calculation T_{m MAX} and T_{m MIN}, i.e., RG-1, with the electric motor speed (ωₘ)

A motor friction map MP-M, T=ƒ(ωₘ), is used to calculate the max/min torque value of electric motors, as shown for example in FIG. 9.

Given the electric motor speed, the corresponding max/min torque value is obtained.

### Step 2

The algorithm AG residing in the vehicle braking/traction control unit 6, e.g., in the second control module 13, receives the necessary information (motors, batteries, brakes) as input, then the first input information I1, the second input information I2, the third input information I3, and the fourth input information I4, and solves a real-time optimization problem to allocate the various torques between axles/corners of the vehicle 1 and between brakes/electric motors of the braking system 2 of the vehicle 1.

The constraints serve to ensure that the torque requests from the driver/braking balance module are respected.

The latter equation ensures that no more power is regenerated than the battery can manage.

The cost function is the essential part of the algorithm AG.

Different strategies can be implemented by varying the weight of the coefficients α and β.

For example: it is possible to decide to use more or fewer brakes/electric motors to reach a given desired temperature.

$$arg min {\sum }_{x = F L , F R , R L , RR} {{α}_{x} ( {T}_{m AG x} )}^{2} + {\sum }_{x = F L , F R , R L , R R} {{β}_{x} ( {T}_{b AG x} )}^{2}$$

$$\begin{matrix}{T}_{m A G FL} + {T}_{b AG FL} = {T}_{target LA GF L} \\ {T}_{m AG FR} + {T}_{b AG FR} = {T}_{target LA GF R} \\ {T}_{m AG RL} + {T}_{b AG RL} = {T}_{target LA GR L} \\ {T}_{m A G RR} + {T}_{b AG RR} = {T}_{target LA GR R} \\ {T}_{m MIN FL} \leq {T}_{m A G FL} \leq {T}_{m MAX FL} \\ {T}_{m MIN FR} \leq {T}_{m AG FR} \leq {T}_{m MAX FR} \\ {T}_{m MIN RL} \leq {T}_{m AG RL} \leq {T}_{m MAX RL} \\ {T}_{m MIN RR} \leq {T}_{m AG RR} \leq {T}_{m MAX RR}\end{matrix}$$

$$\begin{matrix}- inf \leq {T}_{b AG FL} \leq 0 \\ - inf \leq {T}_{b AG FR} \leq 0 \\ - inf \leq {T}_{b AG RL} \leq 0 \\ - inf \leq {T}_{b AG RR} \leq 0\end{matrix}$$

$$\vert {ω}_{m FL} {T}_{m AG FL} \vert + \vert {ω}_{m FR} {T}_{m AG FR} \vert +$$

$$\vert {ω}_{m RL} {T}_{m AG RL} \vert + \vert {ω}_{m RF} {T}_{m AG RR} \vert \leq {P}_{batteτy MAX}$$

where:
FL: front left axle/corner;
FR: front right axle/corner;
RL: rear left axle/corner;
FR: rear right axle/corner;
T_{m AG x}: regenerative braking torque target (RG);
T_{b AG x}: dissipative braking torque target (FD);
T_{target AG x}: braking or traction target (TG) to be imparted to the vehicle;
P_{battery MAX}: maximum deliverable/regenerable battery power (I1, P-8);
T_{m MIN x}: minimum regenerative braking torque or traction value (MN-R);
T_{m MAX x}: maximum regenerative braking torque or traction value (MX-R);
ω_{m x}: motor speed (V-M1, V-M2);
αₓ,βₓ: optimization problem weights.

The values of weights αₓ and βₓ are a function of brake temperature, electric motor temperature, and so on.

For example, with αₓ and βₓ it is possible to favor the use of brakes if they are cold, penalize it if they are too hot, and so on.

### Specific Example

Layout: one electric motor on the front axle, one electric motor on the rear axle, one B-b-W technology actuator on the front axle, one B-b-W technology actuator on the rear axle.

Data: transmission ratio k=10, electric motor features as in FIG. 9, wheel radius R=0.375 [m]

Inputs: front axle target torque (T_{target F}), rear axle target torque (T_{target R}), front/rear axle speed (ω_{F,R}), electric motor speed on the front/rear axle (ω_{m F,R}), maximum battery power (P_{battery MAX}).

Note that for simplicity, except for the gear ratio, both the front/rear axle speeds and the electric motor speeds on the front/rear axle are assumed to be equal and calculated based on the vehicle speed.

### Inputs:

$$\begin{matrix}v = 150 [ km / h ] ; \\ {T}_{target F} = - 50 \; 00 [ Nm ] \\ {T}_{target R} = - 30 \; 00 [ Nm ] \\ {P}_{b α t tery MAX} = 20 [ kW ]\end{matrix}$$

From the vehicle speed, through wheel radius and gear ratio, it is possible to trace back to motor speed, and with the motor friction map MP-M (FIG. 9) it is possible to obtain the maximum and minimum torques.

The algorithm AG solves the following optimization problem.

The output of the algorithm is the torque values T_{AG} i.e., the commands for the two electric motors and the two B-b-W technology actuators.

$$\begin{matrix}arg min {α}_{1} {T}_{m AG F}^{2} + {α}_{2} {T}_{m A G R}^{2} + {β}_{1} {T}_{b AG F}^{2} + {β}_{2} {T}_{b AG R}^{2} \\ {T}_{m AG F} + {T}_{b AG F} = {T}_{target F} \\ {T}_{m AG R} + {T}_{b AG R} = {T}_{target R} \\ {T}_{m MIN F} \leq {T}_{m AG F} \leq {T}_{m MAX F} \\ {T}_{m MIN R} \leq {T}_{m AG R} \leq {T}_{m MAX R} \\ - inf \leq {T}_{b AG F} \leq 0 \\ - inf \leq {T}_{b AG R} \leq 0 \\ \vert {ω}_{m F} {T}_{m AG F} \vert + \vert {ω}_{m R} {T}_{m AG R} \vert \leq {P}_{batteτy MAX}\end{matrix}$$

With the numerical values indicated above, the optimization problem to be solved becomes, with α=0 e β=1:

$$\begin{matrix}arg {min T}_{b AB F}^{2} + {T}_{b AB R}^{2} \\ {T}_{m AG F} + {T}_{b AG F} = - 5 \; 000 Nm \\ {T}_{m AG R} + {T}_{b AG R} = - 3 \; 000 Nm \\ - 1666 Nm \leq {T}_{m AG F} \leq 1666 Nm \\ - 2632 Nm \leq {T}_{m AG R} \leq 2632 Nm \\ - inf \leq {T}_{b AG F} \leq 0 \\ - inf \leq {T}_{b AG R} \leq 0 \\ \vert 111 rad / {sT}_{m AG F} \vert + \vert 111 rad / {sT}_{m AG R} \vert \leq 20 \; 000 W\end{matrix}$$

The outputs of the algorithm AG, as a solution to the aforesaid optimization problem, are as follows:
Front-allocated torque on the electric motor T_{m AG F}: −180.00 [Nm]
Front-allocated torque on the brakes T_{b AG F}: −4820.00 [Nm]
Rear-allocated torque on the electric motor T_{m AG R}: −180.00 [Nm]
Rear-allocated torque on the brakes T_{b AG R}: −4820.00 [Nm]

If the battery power value (600 KW) is changed, for example, the following values are obtained as output (the limit is no longer the battery but the electric motors):
Front-allocated torque on the electric motor T_{m AG F}: −1666.82 [Nm]
Front-allocated torque on the brakes T_{b AG F}: −3333.18 [Nm]
Rear-allocated torque on the electric motor T_{m AG R}: −2632.61 [Nm]
Rear-allocated torque on the brakes T_{b AG R}: −367.39 [Nm]

### APPENDIX 2

### Example of Braking Balancing Performed by the Braking Balancing Sub-Module 6′

The braking balancing sub-module 6′ is responsible for distributing the received total vehicle deceleration/acceleration request from the driver into a target value of front and rear torque.

In this respect, the braking balancing sub-module 6′ directly receives the total target torque or a target deceleration/acceleration.

In the first case, the braking balancing sub-module 6′ converts the torque request to deceleration/acceleration using vehicle data (weight, wheel radius). The braking balancing sub-module 6′ uses the target deceleration/acceleration and vehicle data to calculate the optimal torque distribution between front and rear.

Load transfer was considered in the formulas given below. An advanced form of the braking balancing sub-module 6′ could use a grip estimate provided by the vehicle control unit 5 (VCU).
Input: T_{target vehicle} (or a_{x target})
Output: T_{target F}, T_{target R}

$$\begin{matrix}{a}_{x target} = {T}_{target vehicle} / ( R m ) \\ {T}_{target CF} = ( {l}_{r} / L mg - {h}_{c g} / L m {a}_{x target} \cdot R \\ {T}_{target R} = ( {l}_{f} / L mg + {h}_{c g} / L m {a}_{x target} \cdot R\end{matrix}$$

where:
R: wheel radius;
m: vehicle weight;
L: wheelbase;
lᵣ: rear axle center-of-gravity distance;
l_{ƒ}: front axle center-of-gravity distance;
h_{cg}: center-of-gravity height.

### APPENDIX 3

### Example of Monitoring Performed by the First Monitoring Module 9

### Step 1

Estimation of the motor torque using a respective motor friction map. The motor friction map can be described, for example, by the following equation:

$${T}_{est motoτ} = {k}_{m} {I}_{m} .$$

where
kₘ is the torque constant of the motor;
Iₘ is the measured current.

### Step 2

### Use of a Pad/Brake Friction Map MP-F (Shown in FIG. 10) to Calculate the Braking Torque

$${T}_{est brake} = μ ( PV , Temperature ) {k}_{imp} {P}_{brake}$$

where
kᵢₘₚ: characteristic constant of the braking system 2 of the vehicle 1;
PV: product of hydraulic pressure (in bar) and disc speed (in rad/s);
P_{brake}: braking pressure (in bar);
μ: is the pad/brake friction map MP-F;
Temperature: brake disc temperature (in ° C.).

### Step 3

### Comparison of Target Pair and Estimated Pairs

$${T}_{e τ τ} = \vert {T}_{target} - {T}_{est motoτ} - {T}_{est bτake} \vert$$

if the error is greater than a set threshold, the vehicle corner/axle is deactivated.

### APPENDIX 4

### Example of Determining a Hydraulic Pressure Value FP-1 to be Imparted to the Vehicle 1 Performed by the Friction Map Reversal Sub-Module 14

The friction map reversal algorithm, after receiving a target torque (T_{target}) and braking system data (temperatures, speeds, and so on), calculates the target pressure value (Pₑₛₜ) by finding the zero of the function ƒ(Pₑₛₜ)=T_{target}−μ(PV, Temperature) kᵢₘₚ Pₑₛₜ, employing methods known per se such as bisection or Newton, for example.

1-26. (canceled)

27. A system for controlling braking/traction of an electric or hybrid vehicle, comprising:
a vehicle control unit configured to receive a braking or traction request, said vehicle control unit being configured to determine a braking or traction target value to be imparted to the vehicle, based on said braking or traction request;
a vehicle braking/traction control unit operatively connected to said vehicle control unit,
the vehicle braking/traction control unit being configured to be operatively connected to at least one first electric motor of a braking/traction system of the vehicle, operatively connected to at least one first axle of the vehicle, the vehicle braking/traction control unit being configured to control the at least one first electric motor,
the vehicle braking/traction control unit being configured to be operatively connected to at least one first dissipative braking torque actuation module of the braking/traction system of the vehicle, operatively connected to the at least one first axle, the vehicle braking/traction control unit being configured to control the at least one first dissipative braking torque actuation module;
a battery pack operatively connected to the vehicle braking/traction control unit, the battery pack being configured to store electricity during a braking phase of the vehicle to be supplied to the at least one first electric motor during a traction phase of the vehicle;
the vehicle braking/traction control unit is configured to:
receive the braking or traction target value to be imparted to the vehicle determined by the vehicle control unit of the vehicle based on said braking or traction request;
receive first input information representative of the battery pack;
receive second input information representative of a regenerative braking or traction phase performed by the system on the braking/traction system by means of the at least one first electric motor;
receive third input information representative of a dissipative braking phase performed by the system on the braking/traction system of the vehicle by means of the at least one first dissipative braking torque actuation module;
receive fourth input information representative of an operating condition of the at least one first axle or a vehicle corner connected to the at least one first axle;
determine a first regenerative braking torque or traction target value to be imparted to the vehicle by means of the at least one first electric motor based on the braking or traction target value to be imparted to the vehicle, the first input information, the second input information, the third input information, and the fourth input information;
determine a first dissipative braking torque target value or a first hydraulic pressure target value to be imparted to the vehicle by means of the at least one first dissipative braking torque actuation module, based on the braking or traction target value to be imparted to the vehicle, the first input information, the second input information, the third input information, and the fourth input information.

28. The system according to claim 27, wherein the braking or traction target value to be imparted to the vehicle received from the vehicle control unit is a single braking or traction target value to be imparted to an axle and/or a vehicle corner.

29. The system according to claim 27, wherein the braking or traction target value to be imparted to the vehicle received from the vehicle control unit is an overall braking or traction target value to be imparted to the vehicle, the vehicle braking/traction control unit being configured to determine, based on the received overall braking or traction target value to be imparted to the vehicle, respective regenerative braking torque or traction target values and respective dissipative braking torque target values or respective hydraulic pressure target values to be imparted to each axle and/or each vehicle corner.

30. The system according to claim 29, wherein the vehicle braking/traction control unit comprises a braking balancing sub-module configured to determine, based on the received overall braking or traction target value to be imparted to the vehicle, respective regenerative braking torque or traction target values and respective dissipative braking torque target values or respective hydraulic pressure target values to be imparted to each axle and/or each vehicle corner.

31. The system according to claim 27, wherein the vehicle braking/traction control unit is further configured to receive at least one piece of information representative of an operating condition of the vehicle, the vehicle braking/traction control unit being configured to determine the first regenerative braking torque or traction target value to be imparted to the vehicle by the at least one first electric motor also based on the at least one piece of information representative of an operating condition of the vehicle, the vehicle braking/traction control unit being further configured to determine a first dissipative braking torque target value or a first hydraulic pressure target value to be imparted to the vehicle by means of the at least one first dissipative braking torque actuation module also based on the at least one piece of information representative of an operating condition of the vehicle.

32. The system according to claim 31, wherein the vehicle braking/traction control unit is configured to store the at least one piece of information representative of an operating condition of the vehicle previously received on a case-by-case basis and compare the received at least one piece of information representative of an operating condition of the vehicle with the information representative of an operating condition of the vehicle previously stored to identify the most similar ones and thus improve the performance of the system based on the previously taken actions.

33. The system according to claim 27, wherein the vehicle braking/traction control unit comprises a first monitoring module configured to switch the system to a safe condition in case of an anomaly detected in the system.

34. The system according to claim 33, wherein the first monitoring module comprises a first regenerative braking torque or traction estimation sub-module configured to estimate an estimated regenerative braking torque or traction value imparted to the vehicle by means of the at least one first electric motor, the first regenerative braking torque or traction estimation sub-module being configured to estimate the estimated regenerative braking torque or traction value imparted to the vehicle by means of the at least one first electric motor based on the second input information representative of a regenerative braking or traction phase performed by the system on the braking/traction system of the vehicle by means of the at least one electric motor and a motor friction map, the first monitoring module comprising a second dissipative braking torque estimation sub-module configured to estimate an estimated dissipative braking torque value imparted to the vehicle by means of the at least one first dissipative braking torque actuation module, based on the third input information representative of a dissipative braking phase performed by the system on the braking/traction system of the vehicle by means of the at least one first dissipative braking torque actuation module, the fourth input information representative of an operating condition of the at least one first axle or a vehicle corner connected to the at least one first axle, and a pad/brake friction map.

35. The system according to claim 34, wherein the first monitoring module further comprises a third comparison sub-module configured to compare a difference between the braking or traction target value to be imparted to the vehicle received from the vehicle braking/traction control unit and a sum between the estimated regenerative braking torque or traction value imparted to the vehicle by means of the at least one first electric motor and the estimated dissipative braking torque value imparted to the vehicle by means of the at least one first dissipative braking torque actuation module with a set reference threshold, the first monitoring module being configured, if such a difference is greater than the set reference threshold, to disable both the at least one first electric motor and the at least one first dissipative braking torque actuation module by sending a first disabling signal to the at least one first electric motor and a second disabling signal to the at least one first dissipative braking torque actuation module, respectively.

36. The system according to claim 27, wherein the vehicle braking/traction control unit comprises a second control module configured, by means of an appropriate algorithm, to determine the regenerative braking torque or traction value to be imparted to the vehicle by means of the at least one first electric motor and the dissipative braking torque value or hydraulic pressure value to be imparted to the vehicle by the at least one first dissipative braking torque actuation module.

37. The system according to claim 36, wherein the second control module is configured to determine, employing a respective motor friction map, a maximum regenerative braking torque or traction value and a minimum regenerative braking torque or traction value based on the second input information representative of a regenerative braking or traction phase performed by the system on the braking/traction system of the vehicle by means of the at least one first electric motor.

38. The system according to claim 36, wherein the second control module comprises a friction map reversal sub-module configured to determine, employing a respective pad/brake friction map, a hydraulic pressure value to be imparted to the vehicle by means of the at least one first dissipative braking torque actuation module based on the first dissipative braking torque target value to be imparted to the vehicle by means of the at least one first dissipative braking torque actuation module and the fourth input information representative of an operating condition of the at least one first axle or a vehicle corner connected to the at least one first axle.

39. A method for controlling braking/traction of an electric or hybrid vehicle, comprising steps of:
receiving, by a vehicle control unit, a braking or traction request;
determining, by the vehicle control unit, a braking or traction target value to be imparted to the vehicle, based on said braking or traction request;
receiving, by a vehicle braking/traction control unit operatively connected to said vehicle control unit, the braking or traction target value to be imparted to the vehicle determined by the vehicle control unit based on said braking or traction request;
receiving, by the vehicle braking/traction control unit, first input information representative of a battery pack operatively connected to the vehicle braking/traction control unit, the battery pack being configured to store electricity during a braking phase of the vehicle to be supplied to at least one first electric motor, of a braking/traction system of the vehicle, operatively connected to at least one first axle of the vehicle, during a traction phase of the vehicle, the vehicle braking/traction control unit being operatively connected to the at least one first electric motor, the vehicle braking/traction control unit being configured to control the at least one first electric motor;
receiving, by the vehicle braking/traction control unit, second input information representative of a regenerative braking or traction phase performed by the system on the braking/traction system of the vehicle by means of the at least one first electric motor;
receiving, by the vehicle braking/traction control unit, third input information representative of a dissipative braking phase performed by the system on the braking/traction system of the vehicle by means of at least one first dissipative braking torque actuation module of the braking/traction system of the vehicle, the vehicle braking/traction control unit being operatively connected to the at least one first dissipative braking torque actuation module, the vehicle braking/traction control unit being configured to control the at least one first dissipative braking torque actuation module;
receiving, by the vehicle braking/traction control unit, fourth input information representative of an operating condition of the at least one first axle or a vehicle corner connected to the at least one first axle;
determining, by the vehicle braking/traction control unit, a first regenerative braking torque or traction target value to be imparted to the vehicle by means of the at least one first electric motor, based on the braking or traction target value to be imparted to the vehicle, the first input information, the second input information, the third input information, and the fourth input information;
determining, by the vehicle braking/traction control unit, a first dissipative braking torque target value or a first hydraulic pressure target value to be imparted to the vehicle by means of the at least one first dissipative braking torque actuation module, based on the braking or traction target value to be imparted to the vehicle, the first input information, the second input information, the third input information, and the fourth input information.

40. The method according to claim 39, wherein the braking or traction target value to be imparted to the vehicle received from the vehicle control unit is a single braking or traction target value to be imparted to an axle and/or a vehicle corner.

41. The method according to claim 39, wherein the braking or traction target value to be imparted to the vehicle received from the vehicle control unit is an overall braking or traction target value to be imparted to the vehicle, the method comprising a step of determining, by the vehicle braking/traction control unit, based on the received overall braking or traction target value to be imparted to the vehicle, respective regenerative braking torque or traction target values and respective dissipative braking torque target values or respective hydraulic pressure target values to be imparted to each axle and/or each vehicle corner.

42. The method according to claim 41, wherein the step of determining respective regenerative braking torque or traction target values and respective dissipative braking torque target values or respective hydraulic pressure target values to be imparted to each axle and/or each vehicle corner comprises a step of determining, by a braking balancing sub-module of the vehicle braking/traction control unit, based on the received overall braking or traction target value to be imparted to the vehicle, the respective regenerative braking torque or traction target values and respective dissipative braking torque target values or respective hydraulic pressure target values to be imparted to each axle and/or each vehicle corner.

43. The method according to claim 39, further comprising a step of receiving, by the vehicle braking/traction control unit, at least one piece of information representative of an operating condition of the vehicle, the first regenerative braking torque or traction target value to be imparted to the vehicle by the at least one first electric motor being determined, by the vehicle braking/traction control unit, also based on the at least one piece of information representative of an operating condition of the vehicle, the first dissipative braking torque target value or the first hydraulic pressure target value to be imparted to the vehicle by means of the at least one first dissipative braking torque actuation module being determined, by the vehicle braking/traction control unit, also based on the at least one piece of information representative of an operating condition of the vehicle.

44. The method according to claim 43, further comprising steps of:
storing, by the vehicle braking/traction control unit, the at least one piece of information representative of an operating condition of the vehicle previously received on a case-by-case basis;
comparing, by the vehicle braking/traction control unit, the received at least one piece of information representative of an operating condition of the vehicle with the information representative of an operating condition of the vehicle previously stored to identify the most similar ones and thus improve the performance of the method based on the previously taken actions.

45. The method according to claim 39, comprising a step of switching, by a first monitoring module of the vehicle braking/traction control unit, a system for controlling braking/traction of an electric or hybrid vehicle to a safe condition in case of an anomaly detected in the system.

46. The method according to claim 45, wherein the step of switching the system to a safe condition comprises a step of estimating, by a first regenerative braking torque or traction estimation sub-module of the first monitoring module, an estimated regenerative braking torque or traction value imparted to the vehicle by means of the at least one first electric motor, based on the second input information representative of a regenerative braking or traction phase performed by the system on the braking/traction system of the vehicle by means of the at least one electric motor and a motor friction map.

47. The method according to claim 46, wherein the step of switching the system to a safe condition comprises a step of estimating, by a second dissipative braking torque or hydraulic pressure estimation sub-module of the first monitoring module, a dissipative braking torque value imparted to the vehicle by means of the at least one first dissipative braking torque actuation module, based on the third input information representative of a dissipative braking phase performed by the system on the braking/traction system of the vehicle by means of the at least one first dissipative braking torque actuation module, the fourth input information representative of an operating condition of the at least one first axle or a vehicle corner connected to the at least one first axle, and a pad/brake friction map.

48. The method according to claim 47, wherein the step of switching the system to a safe condition comprises a step of comparing, by a third comparison sub-module of the first monitoring module, a difference between the braking or traction target value to be imparted to the vehicle received from the vehicle braking/traction control unit and a sum between the estimated regenerative braking torque or traction value imparted to the vehicle by the at least one first electric motor and the estimated dissipative braking torque value imparted to the vehicle by means of the at least one first dissipative braking torque actuation module with a set reference threshold.

49. The method according to claim 48, wherein the step of switching the system to a safe condition comprises a step of disabling, by the at least one first monitoring module, if such a difference is greater than the set reference threshold, both the at least one first electric motor and the at least one first dissipative braking torque actuation module by sending a first disabling signal to the at least one first electric motor and a second disabling signal to the at least one first dissipative braking torque actuation module, respectively.

50. The method according to claim 39, wherein the step of determining the regenerative braking torque or traction value to be imparted to the vehicle by means of the at least one first electric motor and the step of determining the dissipative braking torque value or the hydraulic pressure value to be imparted to the vehicle by means of the at least one first dissipative braking torque actuation module is performed, by means of an appropriate algorithm, by a second control module of the vehicle braking/traction control unit.

51. The method according to claim 50, wherein the step of determining the first regenerative braking torque or traction target value to be imparted to the vehicle by means of the at least one first electric motor comprises a step of determining, by the second control module, employing a respective motor friction map, a maximum regenerative braking torque or traction value and a minimum regenerative braking torque or traction value based on the second input information representative of a regenerative braking or traction phase performed on the braking/traction system of the vehicle by means of the at least one first electric motor.

52. The method according to claim 50, comprising a step of determining, by a friction map reversal sub-module of the second control module, employing a respective pad/brake friction map, a hydraulic pressure target value to be imparted to the vehicle by means of the at least one first dissipative braking torque actuation module, based on the first dissipative braking torque target value or the first hydraulic pressure target value to be imparted to the vehicle by means of the at least one first dissipative braking torque actuation module, and the fourth input information representative of an operating condition of the at least one first axle or a vehicle corner connected to the at least one first axle.
